(19) United States
(12) Patent Application Publication
(10) Pub. No.: US 2026/0267752 A1
(43) Pub. Date: Sep. 10, 2026

(54) DATA ROUTING METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Guanghua LAN, Shenzhen (CN); Weihao YAN, Shenzhen (CN); Shichao WU, Shenzhen (CN)

(73) Assignee: TENCENT TECHNOLOGY (SHENZHEN) COMPANY LIMITED, Shenzhen (CN)

(21) Appl. No.: 19/660,529

(22) Filed: Apr. 28, 2026

Related U.S. Application Data
(63) Continuation of application No. PCT/CN2025/079171, filed on Feb. 26, 2025.

(30) Foreign Application Priority Data
Feb. 28, 2024 (CN) 202410226346.7

(51) Int. Cl. G06F 11/20

(52) U.S. Cl. CPC G06F 11/2025; G06F 2201/805

(57) ABSTRACT

Data routing methods and apparatus for fault-tolerant network path management in distributed service systems. A management node generates and transmits a first routing path to a first service node containing routing nodes for data routing. Upon receiving a path acquisition request indicating a faulty routing node exists, the management node generates a second routing path excluding the faulty node and transmits it to the first service node. The service node performs path detection to identify faults, requests alternative paths when needed, and performs data routing according to functional paths. The system supports multiple path generation, performance-based path selection, and dynamic path switching, enabling reliable data routing despite node failures through automated fault detection and recovery mechanisms.

### CROSS-REFERENCE TO RELATED APPLICATIONS

This application is a continuation application of International Application No. PCT/CN2025/079171 filed on Feb. 26, 2025 which claims priority to Chinese Patent Application No. 202410226346.7, filed with the China National Intellectual Property Administration on Feb. 28, 2024, the disclosures of each being incorporated by reference herein in their entireties

### FIELD

The disclosure relates to the field of computer technologies, a data routing method and apparatus, an electronic device, a computer-readable storage medium, and a computer program product.

### BACKGROUND

A cluster technology is a technology that has emerged recently with development of the Internet, which connects a group of mutually independent computers by using a high-speed network, to form a cluster system capable of unified management and scheduling, for processing services in various big data scenarios, thereby improving scalability and reliability of the services. To ensure normal operation of the services in the big data scenarios, the cluster system typically stores a massive amount of data to support various services in the big data scenarios.

In a related technology, for data routing, data routing is generally performed directly according to a routing path. When a faulty first routing node exists in the routing path, data routing cannot be performed. Consequently, data routing cannot be normally performed due to a path fault.

### SUMMARY

Provided are data routing methods and apparatus, a device, a storage medium, and a program product, which can implement fault-tolerant data routing through dynamic path management and automatic fault detection with path regeneration capabilities.

According to some embodiments, a data routing method, performed by a management node, includes: generating a first routing path having a first service node as a start point; transmitting the first routing path to the first service node, the first routing path including at least one routing node configured to perform data routing; receiving a path acquisition request from the first service node, the path acquisition request being generated based on a faulty first routing node existing in the at least one routing node; generating, based on the path acquisition request, a second routing path having the first service node as a start point; and transmitting the second routing path to the first service node, the second routing path being different from the first routing path and not including the first routing node.

According to some embodiments, a data routing method, performed by a first service node, includes: receiving a first routing path having the first service node as a start point, the first routing path including at least one routing node configured to perform data routing; transmitting a path acquisition request in response to a faulty first routing node existing in the at least one routing node; receiving a second routing path based on the path acquisition request, the second routing path being different from the first routing path and not including the faulty first routing node; and performing data routing according to the second routing path.

According to some embodiments, a data routing apparatus includes: at least one memory configured to store program code; and at least one processor configured to read the program code and operate as instructed by the program code, the program code including: generation code configured to cause at least one of the at least one processor to generate a first routing path having a first service node as a start point; transmission code configured to cause at least one of the at least one processor to transmit the first routing path to the first service node, the first routing path including at least one routing node configured to perform data routing; reception code configured to cause at least one of the at least one processor to receive a path acquisition request from the first service node, the path acquisition request being generated based on a faulty first routing node existing in the at least one routing node; path code configured to cause at least one of the at least one processor to generate, based on the path acquisition request, a second routing path having the first service node as a start point; and delivery code configured to cause at least one of the at least one processor to transmit the second routing path to the first service node, the second routing path being different from the first routing path and not including the first routing node.

According to some embodiments, a non-transitory computer-readable storage medium, storing computer code which, when executed by at least one processor, causes the at least one processor to at least: generate a first routing path having a first service node as a start point; transmit the first routing path to the first service node, the first routing path including at least one routing node configured to perform data routing; receive a path acquisition request from the first service node, the path acquisition request being generated based on a faulty first routing node existing in the at least one routing node; generate, based on the path acquisition request, a second routing path having the first service node as a start point; and transmit the second routing path to the first service node, the second routing path being different from the first routing path and not including the first routing node.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of skill in the art may still derive other drawings from these accompanying drawings without creative efforts. In addition, one of skill would understand that aspects of some embodiments may be combined together or implemented alone.

FIG. 1 is a schematic architectural diagram of a data routing system 100 according to some embodiments.

FIG. 2 is a schematic structural diagram I of an electronic device for data routing according to some embodiments.

FIG. 3 is a schematic structural diagram II of an electronic device for data routing according to some embodiments.

FIG. 4 is a schematic structural diagram III of an electronic device for data routing according to some embodiments.

FIG. 5 is a schematic structural diagram IV of an electronic device for data routing according to some embodiments.

FIG. 6 is a schematic architectural diagram of a distributed service system according to some embodiments.

FIG. 7 is a schematic flowchart I of a data routing method according to some embodiments.

FIG. 8 is a schematic flowchart II of a data routing method according to some embodiments.

FIG. 9 is a schematic diagram I of a principle of data routing method according to some embodiments.

FIG. 10 is a schematic diagram II of a principle of a data routing method according to some embodiments.

FIG. 11 is a schematic flowchart III of a data routing method according to some embodiments.

FIG. 12 is a schematic flowchart IV of a data routing method according to some embodiments.

FIG. 13 is a schematic flowchart V of a data routing method according to some embodiments.

FIG. 14 is a schematic flowchart VI of a data routing method according to some embodiments.

FIG. 15 is a schematic flowchart VII of a data routing method according to some embodiments.

FIG. 16 is a schematic diagram III of a principle of a data routing method according to some embodiments.

FIG. 17 is a schematic diagram IV of a principle of a data routing method according to some embodiments.

FIG. 18 is a schematic diagram V of a principle of a data routing method according to some embodiments.

FIG. 19 is a schematic diagram VI of a principle of a data routing method according to some embodiments.

FIG. 20 is a schematic diagram VII of a principle of a data routing method according to some embodiments.

FIG. 21 is a schematic diagram VIII of a principle of a data routing method according to some embodiments.

FIG. 22 is a schematic diagram IX of a principle of a data routing method according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the following descriptions, “some embodiments” involved describe a subset of all possible embodiments. However, “some embodiments” may be the same subset or different subsets of all the possible embodiments, and may be combined with each other without conflict.

The term, involved in the following description, “first/second/third” is merely intended to distinguish similar objects rather than describing a order of the objects. The term “first/second/third” is interchangeable in proper circumstances to enable some embodiments to be implemented in other orders than those illustrated or described herein.

Unless otherwise defined, meanings of all technical and scientific terms used herein are the same as those usually understood by a person skilled in the art to which this application belongs. Terms used herein are merely intended to describe some embodiments, but are not intended to limit this application.

Before some embodiments are further described in detail, nouns and terms involved in some embodiments are described, and the nouns and terms involved in some embodiments are applicable to the following explanations.
1) “In response to” is configured for representing a condition or state on which a performed operation depends. When the condition or state on which the performed operation depends is met, one or more performed operations may be performed in real time, or may be performed after a set delay. Unless particularly described, a plurality of performed operations are not limited to an execution sequence.
2) A cloud technology refers to a hosting technology that unifies a series of resources such as hardware, software, and networks in a wide area network or a local area network, to implement computing, storage, processing, and sharing of data. The cloud technology is a generic term of a network technology, an information technology, an integration technology, a management platform technology, an application technology, and the like based on application of a cloud computing business mode, and may form a resource pool, which is used as required, and is flexible and convenient. A cloud computing technology is becoming an important support. A backend service of a technical network system requires a large number of computing and storage resources, such as a video website, a picture website, and more portal websites. Accompanied with the high-level development and application of the Internet industry, every item may have its own identification mark in the future, which may be transmitted to a back-end system for logical processing. Data at different levels may be processed separately, and various types of industry data require strong system back support, which can only be implemented through cloud computing.
3) A Hadoop distributed file system (HDFS) refers to a distributed file system designed to run on commodity hardware. The distributed file system has many points in common with an existing distributed file system, but meanwhile, the distributed file system is also obviously different from another distributed file system. The HDFS is a highly fault-tolerant system suitable for deployment on inexpensive machines. The HDFS can provide high-throughput data access and is well-suited for applications with large-scale data sets. The HDFS relaxes some POSIX constraints to achieve a purpose of streaming reading of file system data. The HDFS is characterized by being highly fault-tolerant and is designed to be deployed on low-cost hardware. Moreover, the HDFS provides high throughput to access data of applications, and is suitable for those applications with large data sets. The HDFS relaxes POSIX requirements to enable streaming access to data in a file system.
4) A private network (virtual private cloud, VPC) is a dedicated cloud-based network space built on a cloud platform, providing network services for a tenant' resources on the cloud, and different private networks are completely logically isolated from each other. The tenant may customize a network environment, a routing table, a security policy, and the like. At the same time, the private network supports multiple manners of connecting to the Internet, connecting to another VPC, and connecting to a local IDC of the tenant.
5) High performance networking (HPN) refers to a computer network with a high speed, low latency, and stable performance, typically used in an application field in which a large bandwidth and fast data transmission are required. The HPN is typically applied to scenarios requiring large data transmission, real-time data processing, and high-concurrency connections, for example, in fields such as scientific research, large-scale data centers, cloud computing, and high-performance computing (HPC).
6) A zero-copy technology (remote direct memory access, RDMA) is a network-based zero-copy technology that may directly transmit data from a memory of one host to a memory of another host without passing through a CPU and a memory of a host. The RDMA technology may implement high-bandwidth and low-latency data transmission by using a dedicated network adapter and a network protocol stack.
7) Segment routing over IPv6 (SRv6) is a network addressing and routing technology, which specifies a path of a data packet by using a segment routing header in an IPv6 data packet header. This technology allows a network administrator to specify a path in a data packet, thereby implementing more flexible and programmable network routing.
8) A queue pair (QP) is similar to a socket pair in network programming. Two independent work queues are packaged in one QP, to transmit data between network nodes. A post action is configured for starting transmitting and receiving of data.
9) A completion queue element (SQE) is configured for describing information of a completed work request (including a completion state, a size, and the like).
10) A cluster technology is a technology that has emerged recently with development of the Internet, which connects a group of mutually independent computers by using a high-speed network, to form a cluster system capable of unified management and scheduling, for processing services in various big data scenarios, thereby improving scalability and reliability of the services. To ensure normal operation of the services in the big data scenarios, a cluster system typically stores a massive amount of data to support various services in the big data scenarios.
11) Nodes include service nodes (such as a first service node and a second service node), routing nodes (such as a first routing node and a second routing node), a management node, and the like. In a telecommunications network, a node is a connection point, representing a redistribution point or a communication endpoint (some terminal devices). A definition of a node depends on the network and protocol layer mentioned. A physical network node is an active electronic device connected to a network, which can transmit, receive, or forward information over a communication channel. Therefore, a passive distribution point (such as a distribution frame or a patch panel) is not a node. In network theory or graph theory, the term “node” refers to a point in a network topology in which lines intersect or branch.
12) Bidirectional forwarding detection (BFS) is a network protocol configured for detecting a fault between two forwarding points. The BFD is a bidirectional forwarding detection mechanism that may provide millisecond-level detection and achieve fast link detection. Through linkage with an upper-layer routing protocol, the BFD may achieve rapid route convergence and ensure service continuity.

During implementation of some embodiments, the applicant finds that the related technology has the following problems:

In a related technology, for data routing, data routing is generally performed directly according to a routing path. When a faulty first routing node exists in the routing path, data routing cannot be performed. Consequently, data routing cannot be normally performed due to a path fault.

Embodiments of this application provide a data routing method and apparatus, an electronic device, a computer-readable storage medium, and a computer program product, which can effectively reduce an influence of a path fault on data routing. An exemplary application of a data routing system provided in some embodiments is described below.

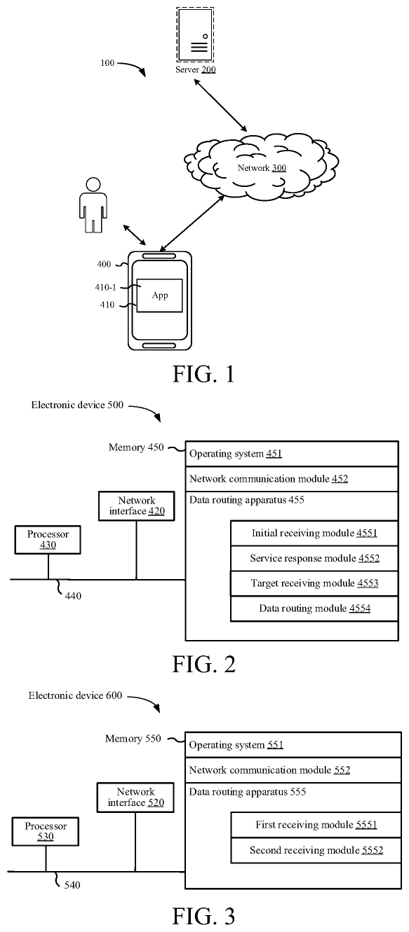

Referring to FIG. 1, FIG. 1 is a schematic architectural diagram of a data routing system 100 according to some embodiments. A terminal (a terminal 400 is exemplarily shown) is connected to a server 200 by using a network 300. The network 300 may be a wide area network, a local area network, or a combination thereof.

The terminal 400 is configured for a user to display a second routing path on a graphical interface 410-1 (the graphical interface 410-1 is exemplarily shown) by using a client 410. The terminal 400 and the server 200 are connected to each other by using a wired or wireless network.

In some embodiments, the server 200 may be an independent physical server, or may be a server cluster including a plurality of physical servers or a distributed system, or may be a cloud server providing cloud computing services, such as a cloud service, a cloud database, cloud computing, a cloud function, cloud storage, a network service, cloud communication, a middleware service, a domain name service, a security service, a content delivery network (CDN), big data, and an artificial intelligence (AI) platform. The terminal 400 may be a smartphone, a tablet computer, a notebook computer, a desktop computer, a smart speaker, a smart television, a smartwatch, an in-vehicle terminal, or the like, but is not limited thereto. The electronic device provided in some embodiments may be implemented as a terminal, or may be implemented as a server. The terminal and the server may be connected directly or indirectly in a wired or wireless communication manner, which is not limited in some embodiments.

In some embodiments, the server 200 receives a first routing path taking a first service node as a start point, transmits a path acquisition request in response to a faulty first routing node existing in at least one routing node, receives a second routing path returned based on the path acquisition request, and transmits the second routing path to the terminal 400. The terminal 400 performs data routing based on the second routing path.

In some other embodiments, the server 400 receives a first routing path taking a first service node as a start point, transmits a path acquisition request in response to a faulty first routing node existing in at least one routing node, receives a second routing path returned based on the path acquisition request, and performs data routing based on the second routing path.

In some other embodiments, some embodiments may be implemented by using a cloud technology. The cloud technology refers to a hosting technology that unifies a series of resources such as hardware, software, and networks in a wide area network or a local area network, to implement computing, storage, processing, and sharing of data.

The cloud technology is a generic term of a network technology, an information technology, an integration technology, a management platform technology, an application technology, and the like based on application of a cloud computing business mode, and may form a resource pool, which is used as required, and is flexible and convenient. A cloud computing technology is becoming an important support. A backend service of a technical network system requires a large number of computing and storage resources

Referring to FIG. 2, FIG. 2 is a schematic structural diagram I of an electronic device for data routing according to some embodiments. An electronic device 500 shown in FIG. 2 may be the server 200 or the terminal 400 in FIG. 1. The electronic device 500 shown in FIG. 2 includes: at least one processor 430, a memory 450, and at least one network interface 420. Components in the electronic device 500 are coupled together by using a bus system 440. The bus system 440 is configured to enable connected communication between these components. In addition to a data bus, the bus system 440 further includes a power bus, a control bus, and a state signal bus. However, for clarity, various buses are marked as the bus system 440 in FIG. 2.

The processor 430 may be an integrated circuit chip having a signal processing capability, for example, a general-purpose processor, a digital signal processor (DSP), another programmable logic device, discrete gate or transistor logic device, or discrete hardware component, or the like. The general-purpose processor may be a microprocessor or any processor, or the like.

The memory 450 may be removable, irremovable, or a combination thereof. An exemplary hardware device includes a solid-state memory, a hard disk drive, an optical disk drive, and the like. In some embodiments, the memory 450 includes one or more storage devices physically located away from the processor 430.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in some embodiments is intended to include any suitable type of memory.

In some embodiments, the memory 450 can store data to support various operations. Examples of the data include a program, a module, a data structure, or a subset or a superset thereof, which are described below by way of example.

An operating system 451 includes system programs configured to process various system services and perform hardware-related tasks, for example, a framework layer, a core library layer, and a driver layer, which are configured to implement various services and process hardware-based tasks.

A network communication module 452 is configured to reach another electronic device by using one or more (wired or wireless) network interfaces 420. Exemplary network interfaces 420 include: Bluetooth, wireless fidelity (Wi-Fi), a universal serial bus (USB), and the like.

In some embodiments, a data routing apparatus provided in some embodiments may be implemented in a software manner. FIG. 2 shows a data routing apparatus 455 that is stored in the memory 450, which may be software in the form of a program and a plugin, including the following software modules: an initial receiving module 4551, a service response module 4552, a target receiving module 4553, and a data routing module 4554. These modules are logical and may be arbitrarily combined or further split according to functions implemented. The functions of the modules are to be explained below.

Referring to FIG. 3, FIG. 3 is a schematic structural diagram II of an electronic device for data routing according to some embodiments. An electronic device 600 shown in FIG. 3 may be the server 200 or the terminal 400 in FIG. 1. The electronic device 600 shown in FIG. 3 includes: at least one processor 530, a memory 550, and at least one network interface 520. Components in the electronic device 600 are coupled together by using a bus system 540. The bus system 540 is configured to implement connection and communication between the components. In addition to a data bus, the bus system 540 further includes a power bus, a control bus, and a state signal bus. However, for clarity, various buses are marked as the bus system 540 in FIG. 3.

The processor 530 may be an integrated circuit chip having a signal processing capability, for example, a general-purpose processor, a DSP, another programmable logic device, discrete gate or transistor logic device, or discrete hardware component, or the like. The general-purpose processor may be a microprocessor or any processor, or the like.

The memory 550 may be removable, irremovable, or a combination thereof. An exemplary hardware device includes a solid-state memory, a hard disk drive, an optical disk drive, and the like. In some embodiments, the memory 550 includes one or more storage devices physically located away from the processor 530.

The memory 550 includes a volatile memory or a non-volatile memory, or may include both a volatile memory and a non-volatile memory. The non-volatile memory may be a ROM, and the volatile memory may be a RAM. The memory 550 described in some embodiments is intended to include any suitable type of memory.

In some embodiments, the memory 550 can store data to support various operations. Examples of the data include a program, a module, a data structure, or a subset or a superset thereof, which are described below by way of example.

An operating system 551 includes system programs configured to process various system services and perform hardware-related tasks, for example, a framework layer, a core library layer, and a driver layer, which are configured to implement various services and process hardware-based tasks.

A network communication module 552 is configured to reach another electronic device by using one or more (wired or wireless) network interfaces 520. Exemplary network interfaces 520 include: Bluetooth, Wi-Fi, a USB, and the like.

In some embodiments, the data routing apparatus provided in some embodiments may be implemented in a software manner. FIG. 3 shows a data routing apparatus 555 that is stored in the memory 550, which may be software in the form of a program and a plugin, including the following software modules: a first receiving module 5551, and a second receiving module 5552. These modules are logical and may be arbitrarily combined or further split according to functions implemented. The functions of the modules are to be explained below.

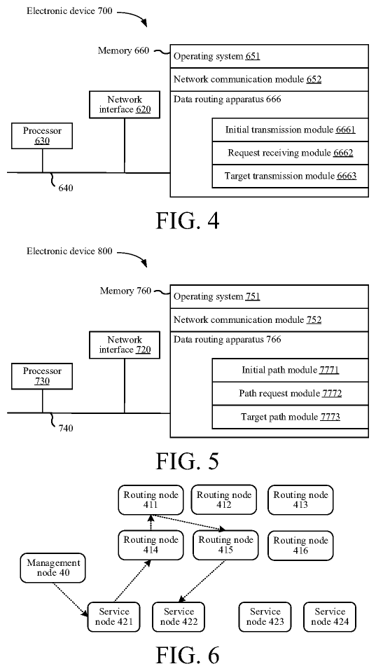

Referring to FIG. 4, FIG. 4 is a schematic structural diagram III of an electronic device for data routing according to some embodiments. An electronic device 700 shown in FIG. 4 may be the server 200 or the terminal 400 in FIG. 1. The electronic device 700 shown in FIG. 4 includes: at least one processor 630, a memory 660, and at least one network interface 620. Components in the electronic device 700 are coupled together by using a bus system 640. The bus system 640 is configured to enable connected communication between these components. In addition to a data bus, the bus system 640 further includes a power bus, a control bus, and a state signal bus. However, for clarity, various buses are marked as the bus system 640 in FIG. 4.

The processor 630 may be an integrated circuit chip having a signal processing capability, for example, a general-purpose processor, a DSP, another programmable logic device, discrete gate or transistor logic device, or discrete hardware component, or the like. The general-purpose processor may be a microprocessor or any processor, or the like.

The memory 660 may be removable, irremovable, or a combination thereof. An exemplary hardware device includes a solid-state memory, a hard disk drive, an optical disk drive, and the like. In some embodiments, the memory 660 includes one or more storage devices physically located away from the processor 630.

The memory 660 includes a volatile memory or a non-volatile memory, or may include both a volatile memory and a non-volatile memory. The non-volatile memory may be a ROM, and the volatile memory may be a RAM. The memory 660 described in some embodiments is intended to include any suitable type of memory.

In some embodiments, the memory 660 can store data to support various operations. Examples of the data include a program, a module, a data structure, or a subset or a superset thereof, which are described below by way of example.

An operating system 651 includes system programs configured to process various system services and perform hardware-related tasks, for example, a framework layer, a core library layer, and a driver layer, which are configured to implement various services and process hardware-based tasks.

A network communication module 652 is configured to reach another electronic device by using one or more (wired or wireless) network interfaces 620. Exemplary network interfaces 620 include: Bluetooth, Wi-Fi, a USB, and the like.

In some embodiments, the data routing apparatus provided in some embodiments may be implemented in a software manner. FIG. 4 shows a data routing apparatus 666 that is stored in the memory 660, which may be software in the form of a program and a plugin, including the following software modules: a first transmission module 6661, a request receiving module 6662, and a target transmission module 6663. These modules are logical and may be arbitrarily combined or further split according to functions implemented. The functions of the modules are to be explained below.

Referring to FIG. 5, FIG. 5 is a schematic structural diagram IV of an electronic device for data routing according to some embodiments. An electronic device 800 shown in FIG. 5 may be the server 200 or the terminal 400 in FIG. 1. The electronic device 700 shown in FIG. 4 includes: at least one processor 730, a memory 760, and at least one network interface 720. Components in the electronic device 700 are coupled together by using a bus system 740. The bus system 740 is configured to enable connected communication between these components. In addition to a data bus, the bus system 740 further includes a power bus, a control bus, and a state signal bus. However, for clarity, various buses are marked as the bus system 740 in FIG. 4.

The processor 730 may be an integrated circuit chip having a signal processing capability, for example, a general-purpose processor, a DSP, another programmable logic device, discrete gate or transistor logic device, or discrete hardware component, or the like. The general-purpose processor may be a microprocessor or any processor, or the like.

The memory 760 may be removable, irremovable, or a combination thereof. An exemplary hardware device includes a solid-state memory, a hard disk drive, an optical disk drive, and the like. In some embodiments, the memory 760 includes one or more storage devices physically located away from the processor 730.

The memory 760 includes a volatile memory or a non-volatile memory, or may include both a volatile memory and a non-volatile memory. The non-volatile memory may be a ROM, and the volatile memory may be a RAM. The memory 760 described in some embodiments is intended to include any suitable type of memory.

In some embodiments, the memory 760 can store data to support various operations. Examples of the data include a program, a module, a data structure, or a subset or a superset thereof, which are described below by way of example.

An operating system 751 includes system programs configured to process various system services and perform hardware-related tasks, for example, a framework layer, a core library layer, and a driver layer, which are configured to implement various services and process hardware-based tasks.

A network communication module 752 is configured to reach another electronic device by using one or more (wired or wireless) network interfaces 720. Exemplary network interfaces 720 include: Bluetooth, Wi-Fi, a USB, and the like.

In some embodiments, the data routing apparatus provided in some embodiments may be implemented in a software manner. FIG. 5 shows a data routing apparatus 766 that is stored in the memory 760, which may be software in the form of a program and a plugin, including the following software modules: an initial path module 7771, a path request module 7772, and a target path module 7773. These modules are logical and may be arbitrarily combined or further split according to functions implemented. The functions of the modules are to be explained below.

In some other embodiments, the data routing apparatus provided in some embodiments may be implemented in a hardware manner. For example, the data routing apparatus provided in some embodiments may be a processor in the form of a hardware decoding processor, programmed to perform the data routing method provided in some embodiments. For example, the processor in the form of the hardware decoding processor may employ one or more application integrated circuits (ASICs), a DSP, a programmable logic device (PLD), a complex programmable logic device (CPLD), a field-programmable gate array (FPGA), or another electronic component.

In some embodiments, the terminal or the server may implement the data routing method provided in some embodiments by running a computer program or a computer-executable instruction. For example, the computer program may be a native program (for example, a dedicated data routing program) or a software module in an operating system, for example, a data routing module that may be embedded in any program (e.g., an instant messaging client, an album program, an electronic map client, or a navigation client); or may be, for example, a native application (APP), for example, a program that can be run only after being installed in an operating system. In summary, the foregoing computer program may be an application program, a module, or a plugin in any form.

The data routing method provided in some embodiments is to be described with reference to the exemplary applications and implementations of the server or terminal provided in some embodiments.

In some embodiments, referring to FIG. 6, FIG. 6 is a schematic architectural diagram of a distributed service system according to some embodiments. The distributed service system provided in some embodiments includes a management node, a plurality of service nodes, and a plurality of routing nodes. For example, the distributed service system shown in FIG. 6 includes a management node 40, a service node 421, a service node 422, a service node 423, a service node 424, a routing node 411, a routing node 412, a routing node 413, a routing node 414, a routing node 415, and a routing node 416.

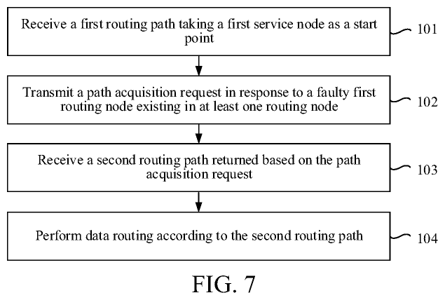

Referring to FIG. 7, FIG. 7 is a schematic flowchart I of a data routing method according to some embodiments. Descriptions are provided with reference to operation 101 to operation 104 shown in FIG. 7. The data routing method provided in some embodiments may be implemented solely by a server or a terminal, or implemented collaboratively by the server and the terminal. The following describes the data routing method implemented solely by the server and from the perspective of a first service node.

In some embodiments, the first service node is any service node in the distributed service system provided in some embodiments. The following describes the data routing method provided in some embodiments from the perspective of the first service node.

Operation 101: Receive a first routing path taking a first service node as a start point.

In some embodiments, the first service node is the start point of the first routing path. The first service node is configured to perform data routing to an end point of the first routing path, is an initial node for data routing, is a communication endpoint in the distributed service system, is an active electronic device connected to the distributed service system, and can transmit, receive, or forward information by using a communication channel. The first routing path includes a start point, an end point, and intermediate waypoints, the start point and the end point of the first routing path are service nodes, and the intermediate waypoints of the first routing path are routing nodes.

In some embodiments, in the distributed service system, the first routing path refers to a data transmission path from the first service node (a start point) to another service node (an end point). This path includes a start point, an end point, and possible intermediate waypoints. The start point and the end point are generally service nodes, for example, nodes performing a service function, while the intermediate waypoints are routing nodes, which are responsible for forwarding data according to a routing policy, to ensure that the data can be efficiently and correctly transmitted from the start point to the end point. The first routing path is the foundation of entire network communication, which defines a path and manner of data transmission. An active electronic device involved can transmit, receive, or forward information by using a communication channel, thereby implementing information exchange and service processing in the distributed service system.

In some embodiments, the first routing path includes at least one routing node configured to perform data routing.

In some embodiments, the routing node is configured to perform data forwarding on routing data originating from and terminating at different service nodes. Data routing refers to a network-wide data transmission process that determines an end-to-end path for a packet from source to destination.

In some embodiments, the service node includes at least one service port, different service ports have different service functions, and the service port is a minimum unit through which the service node communicates with another node.

As an example, referring to FIG. 16, FIG. 16 is a schematic diagram III of a principle of a data routing method according to some embodiments. A service node 1 includes a service port 11, a service port 12, a service port 13, a service port 14, a service port 15, a service port 16, a service port 17, and a service port 18.

As an example, referring to FIG. 6, the first service node (the service node 421) receives a first routing path (for example, the first routing path is: the service node 421-the routing node 414-the routing node 411-the routing node 415-the service node 422) transmitted by the management node 40 and taking the first service node (the service node 421) as a start point.

As an example, referring to FIG. 16, the service port 11 of the service node 1 receives the first routing path taking the service port 11 of the service node 1 as a start point.

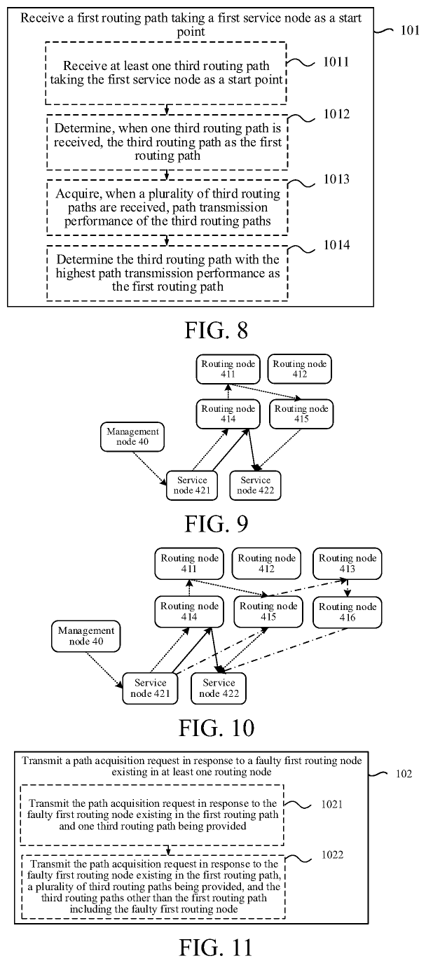

In some embodiments, referring to FIG. 8, FIG. 8 is a schematic flowchart II of a data routing method according to some embodiments. Operation 101 shown in FIG. 7 may be implemented by using operation 1011 to operation 1014 shown in FIG. 8.

Operation 1011: Receive at least one third routing path taking the first service node as a start point.

In some embodiments, the third routing path includes at least one routing node configured to perform data routing. Start points and end points of different third routing paths are the same, but path intermediate points of the different third routing paths are different.

As an example, referring to FIG. 6, the first service node (the service node 421) receives one third routing path (for example, the third routing path is: the service node 421-the routing node 414-the routing node 411-the routing node 415-the service node 422) transmitted by the management node 40 and taking the first service node (the service node 421) as a start point.

As an example, referring to FIG. 9, FIG. 9 is a schematic diagram I of a principle of a data routing method according to some embodiments. The first service node (the service node 421) receives two third routing paths (for example, a third routing path A is: the service node 421-the routing node 414-the routing node 411-the routing node 415-the service node 422; and a third routing path B is: the service node 421-the routing node 414-the service node 422) transmitted by the management node 40 and taking the first service node (the service node 421) as a start point.

Operation 1012: Determine, when one third routing path is received, the third routing path as the first routing path.

Following the foregoing example, when one third routing path is received, for example, the received third routing path is: the service node 421-the routing node 414-the routing node 411-the routing node 415-the service node 422, the received third routing path is directly determined as the first routing path.

In this way, the third routing path taking the first service node as a start point is transmitted to the first service node, and the first service node directly determines the received third routing path as the first routing path. Therefore, by controlling a quantity of transmitted routing paths, transmission time is greatly reduced, thereby significantly improving transmission efficiency of the first routing path.

Operation 1013: Acquire, when a plurality of third routing paths are received, path transmission performance of the third routing paths.

In some embodiments, the path transmission performance is an index configured for measuring a data routing speed of the third routing path. The path transmission performance is in one-to-one correspondence to the third routing paths, and the path transmission performance is positively correlated with a path transmission speed of the corresponding third routing path. A larger value of the path transmission performance indicates a higher corresponding path transmission speed, and lower path transmission performance indicates a lower corresponding path transmission speed.

In some embodiments, the path transmission performance of the third routing path may be a sum of node performance of the routing nodes in the third routing path.

As an example, an expression of the path transmission performance of the third routing path may be:

$$X = {X}_{1} + … + {X}_{n} \qquad ( 1 )$$

where X is configured for indicating path transmission performance of the third routing path, X₁ . . . Xₙ is configured for indicating node performance of each routing node in the third routing path, and n is configured for indicating a quantity of the routing nodes in the third routing path.

In some embodiments, the node performance of each routing node in the third routing path is configured for indicating data processing performance of the routing node. For example, the node performance may be a fusion result of related index parameters such as data throughput, a response time, and a query rate per second of the routing node, which is configured for comprehensively reflecting the data processing performance of the routing node.

In some embodiments, the data throughput refers to an amount of data successfully transmitted per unit time (measured in bits, bytes, packets, or the like) for a network, a device, a port, a virtual circuit, or another facility.

As an example, the node performance of the routing node may be determined in the following manner: performing standardization processing on the data throughput, the response time, and the query rate per second of the routing node, to obtain a standard throughput, a standard response time, and a standard query rate, where dimensions of the standard throughput, the standard response time, and the standard query rate are the same, and performing weighted averaging on the standard throughput, the standard response time, and the standard query rate, to obtain the node performance of the routing node.

Operation 1014: Determine the third routing path with the highest path transmission performance as the first routing path.

Following the foregoing example, referring to FIG. 9, the third routing path A is: the service node 421-the routing node 414-the routing node 411-the routing node 415-the service node 422; and the third routing path B is: the service node 421-the routing node 414-the service node 422. Path transmission performance of the third routing path A is lower than that of the third routing path B. Therefore, the third routing path B with the highest path transmission performance is determined as the first routing path.

As an example, it is assumed that a service node A is a key node in the distributed service system, which may transmit data to a service node Z. There is a known routing path (the first routing path) connecting the service nodes A and Z. Due to a requirement for network maintenance or traffic optimization, the system may seek an alternative routing path (a third routing path). The service node A detects at least one third routing path to the service node Z by using a network discovery mechanism or configuration of an administrator. It is assumed that two possible third routing paths: a path C and a path D, are detected. If the service node A detects only one third routing path, for example, only the path C, the service node A determines the path C as a new first routing path, because a new data transmission option is provided. If detecting a plurality of third routing paths, for example, the path C and the path D, the service node A may evaluate transmission performance of the two paths. To perform evaluation, the service node A may measure performance indexes such as a transmission delay, a packet loss rate, and a bandwidth capacity of each path by transmitting a test data packet. It is assumed that the service node A finds that the path C has an average transmission delay of 50 milliseconds and a packet loss rate of 2%, while the path D has an average transmission delay of 30 milliseconds and a packet loss rate of 1%. The service node A further finds that the bandwidth capacity of the path C is 100 Mbps, while the bandwidth capacity of the path D is 200 Mbps. Based on the transmission performance evaluation, the service node A may determine which path is to become a new first routing path. Assuming that the system attaches more importance to the transmission delay and the packet loss rate, the service node A may select the path D, because the path D is better than the path C in the two indexes. If the path with the highest transmission performance is the path D, the service node A determines the path D as a new first routing path.

In this way, a plurality of third routing paths taking the first service node as a start point are transmitted to the first service node, and the first service node determines the third routing path with the highest path transmission performance as the first routing path, so that the plurality of third routing paths taking the first service node as the start point may be backed up in the first service node, and when a routing node fails in the first routing path, the first service node can directly locally switch to a first routing path not including the faulty first routing node, thereby implementing rapid path switching, which can ensure normal operation of data routing without being affected by the faulty first routing node. Therefore, an influence of a path fault on data routing can be quickly reduced, thereby effectively improving fault avoidance efficiency of the first service node.

In this way, at least one third routing path taking the first service node as a start point is received, and the third routing path with the highest path transmission performance is selected from the third routing paths as the first routing path, to preferentially select the third routing path with the highest path transmission performance for data routing, so that a routing speed of data routing is effectively increased, thereby effectively improving routing efficiency of data routing.

In some embodiments, after operation 101, the second routing path may be determined in the following manner: selecting, in response to a faulty first routing node existing in the first routing path, a plurality of third routing paths being provided, and the third routing paths other than the first routing path not including the faulty first routing node, one third routing path not including the faulty first routing node from the third routing paths other the first routing path as the second routing path.

In some embodiments, the faulty first routing node refers to a faulty routing node. When the routing node is faulty, the routing node cannot perform data forwarding and data routing. When the faulty first routing node exists in the routing path, data routing cannot be normally performed on routing data in the routing path, thereby causing a data routing fault.

In some embodiments, when the faulty first routing node already exists in the first routing path, it indicates that data routing cannot be performed on the first routing path. When a plurality of third routing paths are received by the first service node, one third routing path not including the faulty first routing node may be directly selected from the third routing paths other than the first routing path as the second routing path, so that when the faulty first routing node exists in the first routing path, the first service node directly searches the routing node locally for one third routing path not including the faulty first routing node as the second routing path. Therefore, the first service node does not need to request the second routing path again from the side of the management node, so that the second routing path not including the faulty first routing node can be rapidly found when the first routing path fails, thereby effectively saving a duration of fault repair and effectively improving fault avoidance efficiency.

As an example, referring to FIG. 9, the third routing path A is: the service node 421-the routing node 414-the routing node 411-the routing node 415-the service node 422; and the third routing path B is: the service node 421-the routing node 414-the service node 422, where the third routing path A is the first routing path. When the faulty first routing node (the routing node 411) exists in the third routing path A, a plurality of third routing paths are provided, and one third routing path (the third routing path B) other than the first routing path (the third routing path A) does not include the faulty first routing node (the third routing path B does not include the faulty first routing node, for example, the routing node 411), from the third routing paths other than the first routing path, the third routing path (for example, the third routing path B) not including the faulty first routing node is selected as the second routing path.

In this way, when the faulty first routing node exists in the first routing path and a plurality of third routing paths are available for selection, one path not including the faulty node is selected from these third routing paths as the second routing path, thereby ensuring continuity and reliability of network communication and avoiding breaking of an entire communication link caused by a fault of a single node. By dynamically switching to the second routing path not including the faulty node, the system can quickly recover data transmission without affecting service continuity, thereby reducing an influence of the fault on service operation and improving service availability.

In some embodiments, the selecting, from the third routing paths other than the first routing path, one third routing path not including the faulty first routing node as the second routing path may be implemented in the following manner: determining, when two third routing paths are provided and the third routing path other than the first routing path does not include the faulty first routing node, the third routing path other than the first routing path as the second routing path; and determining, when more than two third routing paths are provided, the third routing paths not including the faulty first routing node in the third routing paths other than the first routing path as fourth routing paths, and determining the second routing path based on the fourth routing paths.

In some embodiments, the fourth routing path refers to one third routing path that is in third routing paths other than the first routing path and does not include the faulty first routing node.

As an example, referring to FIG. 9, when two third routing paths are provided (the third routing path A is: the service node 421-the routing node 414-the routing node 411-the routing node 415-the service node 422; and the third routing path B is: the service node 421-the routing node 414-the service node 422) and the third routing path (the third routing path B) other than the first routing path (the third routing path A) does not include the faulty first routing node (the routing node 411), the third routing path (the third routing path B) other than the first routing path is determined as the second routing path.

As an example, referring to FIG. 10, FIG. 10 is a schematic diagram II of a principle of a data routing method according to some embodiments. When more than two third routing paths are provided (the third routing path A is: the service node 421-the routing node 414-the routing node 411-the routing node 415-the service node 422; the third routing path B is: the service node 421-the routing node 414-the service node 422; and the third routing path C is: the service node 421-the routing node 415-the routing node 413-the routing node 416-the service node 422), the third routing paths (the third routing path B and the third routing path C) not including the faulty first routing node in the third routing paths other than the first routing path (the third routing path A) are determined as fourth routing paths, and the second routing path is determined based on the fourth routing paths.

In some embodiments, when the faulty first routing node already exists in the first routing path, it indicates that data routing cannot be performed on the first routing path. When a plurality of third routing paths are received by the first service node, one third routing path not including the faulty first routing node may be directly selected from the third routing paths other than the first routing path as the second routing path, so that when the faulty first routing node exists in the first routing path, the first service node directly searches the routing node locally for one third routing path not including the faulty first routing node as the second routing path. Therefore, the first service node does not need to request the second routing path again from the side of the management node, thereby avoiding wasting routing time, so that the second routing path not including the faulty first routing node can be rapidly found when the first routing path fails, which eliminates a need to make a request again, thereby effectively saving a duration of fault repair and effectively improving fault avoidance efficiency.

In some embodiments, the determining the second routing path based on the fourth routing paths may be implemented in the following manner: determining, when one fourth routing path is provided, the fourth routing path as the second routing path; and determining, when a plurality of fourth routing paths are provided, the fourth routing path with the highest path transmission performance as the second routing path.

Following the foregoing example, referring to FIG. 10, the fourth routing paths are: the third routing path B: the service node 421-the routing node 414-the service node 422, and the third routing path C: the service node 421-the routing node 415-the routing node 413-the routing node 416-the service node 422. When the path transmission performance of the third routing path B is higher than that of the third routing path C, the third routing path B is determined as the second routing path. When the path transmission performance of the third routing path C is higher than that of the third routing path B, the third routing path C is determined as the second routing path.

In this way, when one fourth routing path is provided in the system, the fourth routing path is directly determined as the second routing path, and when a plurality of fourth routing paths are provided, the path with the highest transmission performance is selected as the second routing path, which ensures that the system can quickly switch to a reliable alternate path when the first routing path fails or is congested, thereby maintaining service continuity and stability. Secondly, by evaluating and selecting the path with optimal transmission performance, the system can provide a more efficient data transmission rate and a lower delay, thereby improving user experience and overall performance of the system. In addition, the policy further enhances flexibility and adaptability of a network, so that the system can dynamically adjust a routing policy according to a real-time network state, optimize resource allocation, and reduce a potential loss caused by a network problem, thereby finally improving reliability and efficiency of the entire distributed service system.

In some embodiments, after operation 101, path detection may be performed on the first routing path in the following manner: performing path detection on the first routing path, to obtain a path detection result.

In some embodiments, the path detection result is configured for indicating whether a faulty first routing node exists in the at least one routing node included in the first routing path.

In some embodiments, the path detection is configured for detecting whether a faulty first routing node exists in the routing nodes included in the first routing path.

In some embodiments, the performing path detection on the first routing path, to obtain a path detection result may be implemented in the following manner: determining a routing node that is in the first routing path and adjacent to the first service node as a third routing node; transmitting, to the first routing node, a path detection packet carrying the first routing path, and receiving feedback information returned by the third routing node based on the path detection packet; determining the path detection result as a first detection result when the feedback information indicates that the path detection packet is capable of detecting a second service node; and determining the path detection result as a second detection result when the feedback information indicates that the path detection packet is incapable of detecting the second service node.

In some embodiments, the first detection result is configured for indicating that the faulty first routing node does not exist in the at least one routing node included in the first routing path.

In some embodiments, the second detection result is configured for indicating that the faulty first routing node exists in the at least one routing node included in the first routing path, and the second service node is a service node located at the end point of the first routing path.

In some embodiments, the path detection packet carries the first routing path, and the path detection packet does not carry routing data, thereby effectively reducing transmission time of the path detection packet, improving detection efficiency of path detection, and enabling rapid determination of the faulty first routing node in the first routing path.

In some embodiments, after the path detection packet carrying the first routing path is transmitted to the first routing node, the third routing node further transmits the path detection packet to a fourth routing node that is in the first routing path and adjacent to the first routing node, until the path detection packet is transmitted to the faulty first routing node or the path detection packet is transmitted to the second service node, so that the second service node or the faulty first routing node gradually feeds the feedback information back to the first service node.

In some embodiments, a routing node that is in the first routing path and adjacent to the first service node is selected as the third routing node. This operation is critical, because the third routing node is used as an intermediate point during the detection, and a feedback thereof directly reflects a state of the first routing path. A detection packet carrying first routing path information is transmitted to the first routing node. The packet includes enough information, so that the third routing node can identify and process the detection request. After receiving the detection packet, the first routing node may forward the detection packet to the third routing node. The third routing node performs processing according to packet content and returns feedback information. If the feedback information indicates that the path detection packet successfully reaches the second service node, it means that the first routing path is valid and has no fault or congestion. In this case, the path detection result is determined as the first detection result, indicating that the path is normal. If the feedback information shows that the path detection packet fails to reach the second service node, it may indicate that there is a fault, congestion, or misconfiguration on the first routing path. In this case, the path detection result is determined as the second detection result, indicating that there is a problem with the path. When it is detected that there is a problem with the first routing path, the system may quickly take an action, for example, select an alternate routing path, thereby improving flexibility and robustness of the network.

As an example, referring to FIG. 9, when the first routing path is: the service node 421-the routing node 414-the routing node 411-the routing node 415-the service node 422, the service node 421 is the first service node, the routing node 414 that is in the first routing path and adjacent to the first service node (the service node 421) is determined as the first routing node, and the first service node (the service node 421) transmits, to the first routing node (the routing node 414), a path detection packet carrying the first routing path. When the routing node 414 is not the faulty first routing node, the routing node 414 transmits the path detection packet to the routing node 411. When the routing node 411 is not the faulty first routing node, the routing node 411 transmits the path detection packet to the routing node 415. When the routing node 415 is not the faulty first routing node, the routing node 415 transmits the path detection packet to the second service node 422. The second service node 422 transmits, to the routing node 415, a first detection result indicating that the faulty first routing node does not exist in the at least one routing node included in the first routing path. The first detection result is fed back to the service node 421 by using the routing node 411 and the routing node 414. The first service node 421 forwards the first detection result to the management node 40.

In this way, a routing node adjacent to the first service node is determined as the third routing node, so that a controllable intermediate node is introduced during the detection, which helps to more accurately evaluate reachability and performance of the first routing path. By transmitting the detection packet carrying the first routing path information and receiving the feedback information of the third routing node, the system can effectively determine accessibility of the path, ensuring timely detection of a potential network problem. The path detection result is divided into the first detection result (the second service node can be detected) and the second detection result (the second service node cannot be detected), so that the system can clearly distinguish validity of the routing paths, thereby quickly responding and taking measures, such as selecting an alternate path or performing troubleshooting. Such a path detection mechanism improves a detection capability of the network, ensures high reliability of data transmission, also optimizes a failure diagnosis and recovery procedure, and finally improves stability and quality of service of an entire distributed network.

As an example, referring to FIG. 9, when the first routing path is: the service node 421-the routing node 414-the routing node 411-the routing node 415-the service node 422, the service node 421 is the first service node, the routing node 414 that is in the first routing path and adjacent to the first service node (the service node 421) is determined as the first routing node, and the first service node (the service node 421) transmits, to the first routing node (the routing node 414), a path detection packet carrying the first routing path. When the routing node 414 is not the faulty first routing node, the routing node 414 transmits the path detection packet to the routing node 411. When the routing node 411 is the faulty first routing node, the routing node 411 transmits, to the routing node 414, feedback information configured for indicating that the path detection packet is incapable of detecting the second service node, and the routing node 414 transmits the feedback information to the service node 421. When the feedback information indicates that the path detection packet is incapable of detecting the second service node, the path detection result is determined as the second detection result configured for indicating that the faulty first routing node exists in the at least one routing node included in the first routing path.

As an example, referring to FIG. 10, when the first routing path is: the service node 421-the routing node 414-the service node 422, the service node 421 is the first service node, the routing node 414 that is in the first routing path and adjacent to the first service node (the service node 421) is determined as a third routing node, and the first service node (the service node 421) transmits, to the third routing node (the routing node 414), a path detection packet carrying the first routing path. When the routing node 414 is not the faulty first routing node, the routing node 414 transmits the path detection packet to the second service node 422. The second service node 422 transmits, to the routing node 414, a first detection result indicating that the faulty first routing node does not exist in the at least one routing node included in the first routing path. The routing node 414 feeds the first detection result back to the first service node 421. The first service node 421 forwards the first detection result to the management node 40.

In this way, the path detection packet carries the first routing path, and the path detection packet does not carry routing data, which, by using a lightweight path detection packet, effectively reduces transmission time of the path detection packet, improves detection efficiency of path detection, and enables rapid determination of the faulty first routing node in the first routing path.

In some embodiments, after path detection is performed on the first routing path to obtain a path detection result, data routing may further be performed in the following manner: acquiring routing data in response to a data routing instruction; and performing, in response to the faulty first routing node not existing in the at least one routing node, data routing based on the routing data and according to the first routing path.

In some embodiments, when data routing is triggered after the path detection result is obtained, data routing may be directly performed based on the acquired routing data and according to the first routing path when the path detection result indicates that the faulty first routing node does not exist in the first routing path.

In some embodiments, data routing is triggered after the path detection result is obtained, and data routing may be performed based on the acquired routing data and according to the second routing path when the path detection result indicates that the faulty first routing node exists in the first routing path.

As an example, it is assumed that a distributed network includes a service node A (a first service node), a service node Z (a second service node), and a plurality of routing nodes, which jointly form a communication infrastructure of the network. The service node A may transmit a batch of data to the service node Z. During the detection, the service node A determines a routing node adjacent thereto as a third routing node, and transmits a detection packet carrying first routing path information thereto. The third routing node processes the detection packet and returns feedback information. Assuming that the feedback information indicates that the path detection packet successfully reaches the service node Z, it means that the first routing path is valid. After receiving a path detection result, the service node A receives a data routing instruction, instructing the service node A to start transmitting data to the service node Z. In addition, the service node A acquires routing data. The data may include information such as a destination address, a data packet size, and a transmission protocol. Before starting data routing, the service node A checks all involved routing nodes, to ensure that there is no faulty first routing node. This operation is completed by detecting real-time state information of the system or by transmitting a heartbeat signal to the routing nodes. After confirming that all the routing nodes are operating normally, the service node A starts transmitting data to the service node Z based on the routing data and according to the first routing path. The data may pass through a series of routing nodes, and each node may perform forwarding according to routing information in the data packet, until the data reaches a final destination.

In this way, after path detection is performed on the first routing path and a detection result is acquired, routing data is acquired according to the data routing instruction, and data routing is performed based on the routing data when it is confirmed that no fault occurs in the at least one routing node, which ensures that a path passed by the data is verified before the data is transmitted, and effectively avoids data transmission failure caused by a path fault, thereby improving a success rate and reliability of data transmission. This further helps to reduce a network delay caused by a routing error or a faulty node, thereby optimizing data transmission efficiency. In addition, such a routing decision-making mechanism based on a real-time state enhances flexibility and adaptability of the network, so that the system can quickly respond to a network change, maintain service continuity, and improve overall network performance and user experience.

In some embodiments, the performing data routing based on the routing data and according to the first routing path may be implemented in the following manner: determining a routing node that is in the first routing path and adjacent to the first service node as a third routing node; and performing packet fusion on the routing data and the first routing path, to obtain a first routing packet, and transmitting the first routing packet to the third routing node.

In some embodiments, since it has been determined, before data routing is performed based on the routing data and according to the first routing path, that the faulty first routing node does not exist in the first routing path, packet fusion may be performed on the routing data and the first routing path, to obtain a first routing packet, and the first routing packet is transmitted to the first routing node, thereby implementing routing of the routing data to the end point of the first routing path according to the first routing path.

As an example, referring to FIG. 9, when the first routing path is: the service node 421-the routing node 414-the routing node 411-the routing node 415-the service node 422, the service node 421 is the first service node, the routing node 414 that is in the first routing path and adjacent to the first service node (the service node 421) is determined as the first routing node, the first service node (the service node 421) transmits a first routing packet to the first routing node (the routing node 414), the routing node 414 transmits the first routing packet to the routing node 411, the routing node 411 transmits the first routing packet to the routing node 415, and the routing node 415 transmits the first routing packet to the second service node 422, thereby implementing routing of the routing data from the routing node to the second routing node according to the first routing path.

As an example, referring to FIG. 10, when the first routing path is: the service node 421-the routing node 414-the service node 422, the service node 421 is the first service node, the routing node 414 that is in the first routing path and adjacent to the first service node (the service node 421) is determined as the first routing node, the first service node (the service node 421) transmits a first routing packet to the first routing node (the routing node 414), and the routing node 414 transmits the first routing packet to the second service node 422, thereby implementing routing of the routing data from the routing node to the second routing node according to the first routing path.

In some embodiments, since it has been determined, before data routing is performed based on the routing data and according to the first routing path, that the faulty first routing node does not exist in the first routing path, packet fusion may be performed on the routing data and the first routing path, to obtain a first routing packet, and the first routing packet is transmitted to the first routing node, without a need for repeated packet transmission, thereby implementing routing of the routing data to the end point of the first routing path (the second routing node) according to the first routing path and accurately implementing data routing based on the first routing path.

In some other embodiments, after operation 101, alternatively, whether the first routing path includes the faulty first routing node may also be accurately determined without performing path detection by using the path detection packet. Descriptions are provided below.

In some embodiments, after operation 101, data routing may be performed on the first routing path in the following manner: acquiring routing data in response to a data routing instruction, and performing packet fusion on the routing data and the first routing path, to obtain a first routing packet; and determining a routing node that is in the first routing path and adjacent to the first service node as a third routing node, and transmitting the first routing packet to the third routing node.

In some embodiments, when data routing is triggered (the data routing instruction is generated) before it is known whether the faulty first routing node exists in the first routing path, packet fusion may be performed on the routing data and the first routing path, to obtain a first routing packet. In this case, it is assumed by default that the faulty first routing node does not exist in the first routing path, and data routing is directly performed by using the first routing path. A routing node that is in the first routing path and adjacent to the first service node is determined as a third routing node, the first routing packet is transmitted to the first routing node, and data routing is continued by using the first routing node, until the routing is performed to the faulty first routing node or the second service node (the end point of the first routing path).

As an example, referring to FIG. 9, when the first routing path is: the service node 421-the routing node 414-the routing node 411-the routing node 415-the service node 422, the service node 421 is the first service node, the routing node 414 that is in the first routing path and adjacent to the first service node (the service node 421) is determined as the first routing node, and the first service node (the service node 421) transmits a first routing packet to the first routing node (the routing node 414). When the routing node 414 is not the faulty first routing node, the routing node 414 transmits the first routing packet to the routing node 411. When the routing node 411 is not the faulty first routing node, the routing node 411 transmits the first routing packet to the routing node 415. When the routing node 415 is not the faulty first routing node, the routing node 415 transmits the first routing packet to the service node 422.

As an example, referring to FIG. 9, when the first routing path is: the service node 421-the routing node 414-the routing node 411-the routing node 415-the service node 422, the service node 421 is the first service node, the routing node 414 that is in the first routing path and adjacent to the first service node (the service node 421) is determined as the first routing node, and the first service node (the service node 421) transmits an initial routing packet to the first routing node (the routing node 414). When the routing node 414 is not the faulty first routing node, the routing node 414 transmits the initial routing packet to the routing node 411. When the routing node 411 is the faulty first routing node, the routing node 411 transmits, to the routing node 414, feedback information configured for indicating that the initial routing packet is incapable of detecting the second service node, and the routing node 414 transmits the feedback information to the service node 421. When the feedback information indicates that the initial routing packet is incapable of detecting the second service node, path information of the first routing path is determined as target path information.

In some embodiments, the target path information is configured for indicating that the faulty first routing node exists in the at least one routing node included in the first routing path.

In this way, the routing data is fused with the first routing path to generate the first routing packet, and data routing is performed accordingly, which, by using packet fusion, simplifies a data transmission process, reduces overheads in the transmission, and improves data transmission efficiency. In addition, the third routing node adjacent to the first service node is determined as a next hop for data transmission, which may ensure that data has undergone precise path planning before entering a complex network environment, thereby reducing uncertainty of the data during transmission. The fusion and directional transmission method further helps to optimize utilization of network resources, reduce possible network congestion, improve overall network performance, and finally provide users with a faster and stable data transmission service.

In some embodiments, after the first routing packet is transmitted to the first routing node, the target path information may be determined in the following manner: determining path information of the first routing path as the target path information in response to fault information transmitted by a routing node in the first routing path.

In some embodiments, the target path information is configured for indicating that the faulty first routing node exists in the at least one routing node included in the first routing path.

In some embodiments, after the first routing packet is transmitted to the first routing node, reference routing information may be determined in the following manner: determining path information of the first routing path as reference path information in response to routing success information transmitted by the second service node in the first routing path.

In some embodiments, the reference path information is configured for indicating that the faulty first routing node does not exist in the at least one routing node included in the first routing path.

As an example, it is assumed that the service node A (the first service node) may transmit data to the service node Z (the second service node). The service node A first fuses the routing data with the first routing path, to generate a first routing packet, and transmits the packet to a first routing node adjacent thereto. The service node A transmits the first routing packet to the first routing node, and the node is the first routing node on the first routing path. The first routing packet passes through each routing node on the first routing path, and finally reaches the service node Z. After successfully receiving the data, the service node Z may transmit routing success information back to the service node A, to confirm that the data has been successfully transmitted to the destination. After receiving the routing success information transmitted by the service node Z, the service node A may record path information of the first routing path, which is determined as the reference path information. The reference path information indicates that in an entire data transmission process, at least one routing node on the first routing path (actually, the entire path) does not fail, thereby ensuring success of data transmission.

In this way, since the first routing packet carries the first routing path and the first routing packet carries the routing data, in the process of performing data routing by using the first routing packet, path detection can also be implemented. When the faulty first routing node does not exist in the first routing path, time consumption caused by path detection can be effectively avoided, so that a duration of path detection is greatly shortened, thereby effectively improving routing efficiency of data routing.

Operation 102: Transmit a path acquisition request in response to a faulty first routing node existing in at least one routing node.

In some embodiments, the at least one routing node refers to a routing node in the first routing path. That is, in response to a faulty first routing node existing in at least one routing node means in response to a faulty first routing node existing in the first routing path.

In some embodiments, operation 102 may be implemented in the following manner: responding, by the first service node, to the faulty first routing node existing in the first routing path, and transmitting, by the first service node, a path acquisition request to the management node.

As an example, referring to FIG. 9, when the first routing path is: the service node 421-the routing node 414-the routing node 411-the routing node 415-the service node 422, the first service node (the service node 421) responds to the faulty first routing node existing in the first routing path, and the first service node (the service node 421) transmits a path acquisition request to the management node 40.

In some embodiments, the management node is configured to generate a routing path for the service node to perform data routing.

In this way, when detecting that the faulty first routing node exists in the first routing path, the first service node transmits a path acquisition request to the management node. This mechanism ensures that when a faulty node exists in the network, the first service node can report the situation to a superior management node in time, thereby triggering a fault response and a path reconstruction procedure. Such a proactive error reporting mechanism enables a network administrator to quickly identify and locate a fault point, reducing time required for fault diagnosis. This allows the system to adjust a routing policy in real time, avoid a faulty node, and select a healthy path for data transmission, thereby improving robustness and reliability of the network, ensuring service continuity, and optimizing user experience. Generally, this policy reduces network interruption time and a potential data loss risk caused by a fault, and improves stability and efficiency of the entire distributed network.

In some embodiments, referring to FIG. 11, FIG. 11 is a schematic flowchart III of a data routing method according to some embodiments. Operation 102 shown in FIG. 7 may be implemented by using operation 1021 to operation 1022 shown in FIG. 11.

Operation 1021: Transmit the path acquisition request in response to the faulty first routing node existing in the first routing path and one third routing path being provided.

In some embodiments, the third routing path refers to a routing path initially transmitted by the management node to the first service node. The management node may initially transmit, to the first service node, at least one third routing path taking the first service node as a start point.

In some embodiments, when the first service node responds to the faulty first routing node existing in the first routing path and one third routing path being received by the first service node, the first routing path may be modified to bypass the faulty first routing node, and the path acquisition request can be transmitted only to the management node, to acquire the second routing path not including the faulty first routing node.

As an example, referring to FIG. 9, when the first routing path is: the service node 421-the routing node 414-the routing node 411-the routing node 415-the service node 422, in response to the faulty first routing node existing in the first routing path and one third routing path being provided, the service node 421 transmits a path acquisition request to the management node 40.

Operation 1022: Transmit the path acquisition request in response to the faulty first routing node existing in the first routing path, a plurality of third routing paths being provided, and the third routing paths other than the first routing path including the faulty first routing node.

In some embodiments, when the first service node responds to the faulty first routing node existing in the first routing path and a plurality of third routing paths being provided, the first routing path may be modified to bypass the faulty first routing node, it may be first determined from the plurality of third routing paths whether the third routing paths not including the faulty first routing node exist, and when the third routing paths other than the first routing path include the faulty first routing node, the path acquisition request can be transmitted only to the management node, to acquire the second routing path not including the faulty first routing node.

As an example, referring to FIG. 9, when the first routing path is: the service node 421-the routing node 414-the routing node 411-the routing node 415-the service node 422, the first service node (the service node 421) responds to the faulty first routing node existing in the first routing path, a plurality of third routing paths being provided, and the third routing paths other than the first routing path including the faulty first routing node, and the service node 421 transmits a path acquisition request to the management node 40.

In this way, the path acquisition request is transmitted in response to the faulty first routing node existing in the first routing path and one third routing path being provided, or the path acquisition request is transmitted in response to the faulty first routing node existing in the first routing path, a plurality of third routing paths being provided, and the third routing paths other than the first routing path including the faulty first routing node, so that the first service node may request the second routing path from the management node only when third routing paths not including the faulty first routing node are not locally stored in the first service node, thereby effectively reducing a frequency of requests for the second routing path from the management node, effectively saving a duration of fault repair, and effectively improving fault avoidance efficiency.

Operation 103: Receive a second routing path returned based on the path acquisition request.

In some embodiments, the second routing path is different from the first routing path, and the second routing path does not include the faulty first routing node.

In some embodiments, the first service node receives the second routing path returned by the management node based on the path acquisition request.

As an example, referring to FIG. 9 and FIG. 10, when the first service node is the service node 421, the service node 421 receives the second routing path returned by the management node 40 based on the path acquisition request.

Operation 104: Perform data routing according to the second routing path.

In some embodiments, operation 104 may be implemented in the following manner: performing data routing based on the routing data and according to the second routing path.

As an example, referring to FIG. 9 and FIG. 10, when the first service node is the service node 421, the service node 421 performs data routing based on the routing data and according to the second routing path.

In some embodiments, when the first service node, after receiving the first routing path, generates the first routing packet without performing path detection, the performing data routing based on the routing data and according to the second routing path may be implemented in the following manner: determining a routing node that is in the second routing path and adjacent to the first service node as a second routing node; and performing packet fusion on the routing data and the second routing path, to obtain a second routing packet, and transmitting the second routing packet to the second routing node.

In some embodiments, after the first service node transmits the second routing packet to the second routing node, the second routing node continues performing data routing based on the routing data and according to the second routing path, until the routing data is transmitted to an end point of the second routing path.

As an example, referring to FIG. 9, when the second routing path is: the service node 421-the routing node 414-the routing node 411-the routing node 415-the service node 422, the service node 421 is the first service node, the routing node 414 that is in the second routing path and adjacent to the first service node (the service node 421) is determined as the second routing node, the first service node (the service node 421) transmits a second routing packet to the second routing node (the routing node 414), the routing node 414 transmits the second routing packet to the routing node 411, the routing node 411 transmits the second routing packet to the routing node 415, and the routing node 415 transmits the second routing packet to the second service node 422, thereby implementing routing of the routing data from the routing node to the second routing node according to the second routing path.

As an example, referring to FIG. 10, when the second routing path is: the service node 421-the routing node 414-the service node 422, the service node 421 is the first service node, the routing node 414 that is in the second routing path and adjacent to the first service node (the service node 421) is determined as the first routing node, the first service node (the service node 421) transmits a first routing packet to the first routing node (the routing node 414), and the routing node 414 transmits the first routing packet to the second service node 422, thereby implementing routing of the routing data from the routing node to the second routing node according to the second routing path.

In some embodiments, when the first service node, after receiving the first routing path, performs path detection and does not generate the first routing packet, the performing data routing based on the routing data and according to the second routing path may be implemented in the following manner: updating the first routing path in the first routing packet to the second routing path, to obtain a second routing packet; and determining a routing node that is in the second routing path and adjacent to the first service node as a second routing node, and transmitting the second routing packet to the second routing node.

In some embodiments, after the first service node transmits the second routing packet to the second routing node, the second routing node continues performing data routing based on the routing data and according to the second routing path, until the routing data is transmitted to an end point of the second routing path.

As an example, referring to FIG. 9, when the second routing path is: the service node 421-the routing node 414-the routing node 411-the routing node 415-the service node 422, the service node 421 is the first service node, the routing node 414 that is in the second routing path and adjacent to the first service node (the service node 421) is determined as the second routing node, the first service node (the service node 421) transmits a second routing packet to the second routing node (the routing node 414), the routing node 414 transmits the second routing packet to the routing node 411, the routing node 411 transmits the second routing packet to the routing node 415, and the routing node 415 transmits the second routing packet to the second service node 422, thereby implementing routing of the routing data from the routing node to the second routing node according to the second routing path.

As an example, referring to FIG. 10, when the second routing path is: the service node 421-the routing node 414-the service node 422, the service node 421 is the first service node, the routing node 414 that is in the second routing path and adjacent to the first service node (the service node 421) is determined as the first routing node, the first service node (the service node 421) transmits a first routing packet to the first routing node (the routing node 414), and the routing node 414 transmits the first routing packet to the second service node 422, thereby implementing routing of the routing data from the routing node to the second routing node according to the second routing path.

In this way, the first service node receives a first routing path taking a first service node as a start point, transmits a path acquisition request in response to a faulty first routing node existing in at least one routing node, receives a second routing path returned based on the path acquisition request, and performs data routing based on the second routing path. In this way, when the faulty first routing node exists in the at least one routing node included in the first routing path, the second routing path not including the faulty first routing node is requested and obtained, and data routing is performed by using the second routing path, so as to ensure normal operation of data routing without being affected by the faulty first routing node, thereby effectively reducing an influence of a path fault on data routing.

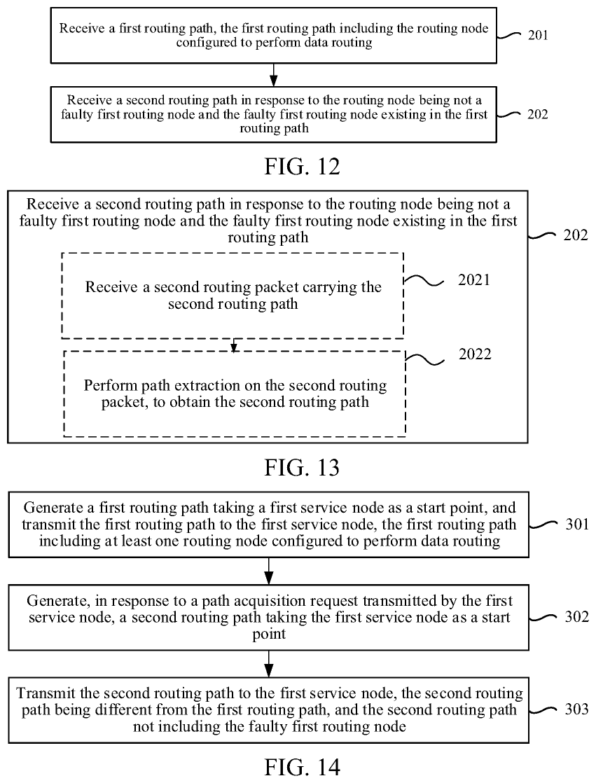

Referring to FIG. 12, FIG. 12 is a schematic flowchart IV of a data routing method according to some embodiments. Descriptions are provided with reference to operation 201 to operation 202 shown in FIG. 12. The data routing method provided in some embodiments may be implemented solely by a server or a terminal, or implemented collaboratively by the server and the terminal. The following describes the data routing method implemented solely by the server and from the perspective of a routing node.

In some embodiments, the routing node is any routing node in the distributed service system provided in some embodiments. The following describes the data routing method provided in some embodiments from the perspective of the routing node.

Operation 201: Receive a first routing path, the first routing path including the routing node configured to perform data routing.

In some embodiments, the routing node receives the routing node configured to perform data routing.

As an example, referring to FIG. 9, when the first routing path is: the service node 421-the routing node 414-the routing node 411-the routing node 415-the service node 422 and the routing node is the routing node 414, the routing node 414 receives the first routing path, and the first routing path includes the routing node 414 configured to perform data routing.

As an example, referring to FIG. 9, when the first routing path is: the service node 421-the routing node 414-the routing node 411-the routing node 415-the service node 422 and the routing node is the routing node 411, the routing node 411 receives the first routing path, and the first routing path includes the routing node 411 configured to perform data routing.

As an example, referring to FIG. 10, when the first routing path is: the service node 421-the routing node 414-the service node 422 and the routing node is the routing node 414, the routing node 414 receives the first routing path, and the first routing path includes the routing node 414 configured to perform data routing.

In some embodiments, after operation 201, the faulty first routing node may be determined in the following manner: determining, when at least two first routing paths are received, for each of the first routing paths, a first node of the routing node in the first routing path; and determining, when at least two identical first nodes exist in the received first routing paths, the routing node as the faulty first routing node.

In some embodiments, when at least two first routing paths are received by the routing node at the same time, for each of the first routing paths, a first node of the routing node in the first routing path is determined.

As an example, referring to FIG. 9, when the routing node is the routing node 414, the routing node 414 receives the first routing path A: the service node 421-the routing node 414-the routing node 411-the routing node 415-the service node 422 and the first routing path B: the service node 421-the routing node 414-the service node 422 at the same time, the first node of the routing node (the routing node 414) in the first routing path A is the routing node 411, and the first node of the routing node (the routing node 414) in the first routing path B is the service node 422. Therefore, if at least two identical first nodes do not exist in the first routing paths received by the routing node, the routing node is not determined as the faulty first routing node.

As an example, referring to FIG. 16, FIG. 16 is a schematic diagram III of a principle of a data routing method according to some embodiments. A distributed service system shown in FIG. 16 includes a service node 1, a service node 2, a service node 3, a service node 4, a routing node LA1, a routing node LA2, a routing node LA3, a routing node LA4, a routing node LC1, and a routing node LC2. When the routing node is the routing node LA1, two first routing paths are received by the routing node LA1 at the same time, at least two identical first nodes (the routing node LC1) exist in the first routing paths received by the routing node LA1, and the routing node LA1 is determined as the faulty first routing node.

In this way, when receiving at least two pieces of first routing path information, the system may compare first nodes in these paths. If finding that the at least two paths include the same first node, it generally means that the node may be a fault point, because the node has a problem in different paths. This policy helps to quickly locate a routing node that may not operate normally due to overload, misconfiguration, or a hardware fault. Timely identification of a faulty node can reduce time of network interruption, increase a fault response speed, and maintain high availability of a network. A false positive rate can also be reduced because a faulty node is determined based on a consensus of a plurality of paths, rather than anomaly of a single path. The fault detection mechanism helps to improve stability and reliability of the network, optimize allocation of network resources, and improve overall quality of service of the network.

In some embodiments, the first node is an end point of the first routing path, or a path distance between the first node and the end point of the first routing path is less than or equal to a path distance between the first node and a start point of the first routing path.

In some embodiments, the first node corresponding to the routing node is a next-hop node of the routing node in the first routing path. The first node may be a service node or a routing node.

In some embodiments, after the first node of the routing node in the first routing path is determined, the faulty first routing node may be determined in the following manner: determining, when at least two identical first nodes exist in the received first routing paths, any one of the received first routing paths as the first routing path; determining the first routing paths other than the first routing path as second routing paths; and determining, for each of the second routing paths, the first node in the second routing path as the first routing node when the first node in the second routing path is not an end point of the second routing path.

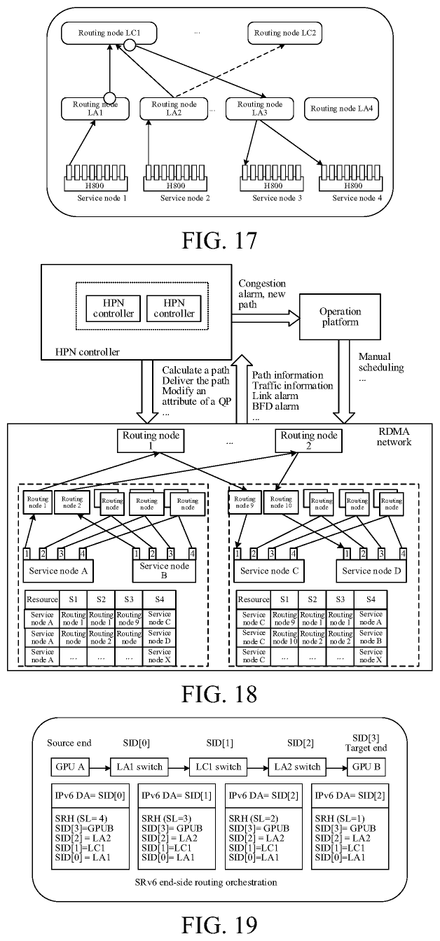

As an example, referring to FIG. 17, FIG. 17 is a schematic diagram IV of a principle of a data routing method according to some embodiments. A distributed service system shown in FIG. 17 includes a service node 1, a service node 2, a service node 3, a service node 4, a routing node LA1, a routing node LA2, a routing node LA3, a routing node LA4, a routing node LC1, and a routing node LC2. When the routing node is the routing node LC1, any one of the received first routing paths is determined as the first routing path (for example, the first routing path may be: the service node 1-the routing node LA1-the routing node LC1-the routing node LA3-the service node 3) when at least two identical first nodes (the routing node LA3) exist in the first routing paths received by the routing node LC1; the first routing paths other than the first routing path are determined as second routing paths (for example, the second routing path may be: the service node 2-the routing node LA2-the routing node LC1-the routing node LA3-the service node 4); and for each of the second routing paths, the first node (the routing node LA3) in the second routing path is determined as the faulty first routing node when the first node (the routing node LA3) in the second routing path is not an end point (the service node 4) of the second routing path.

In some embodiments, the first routing path includes at least one second node in communication connection with the routing node.

In some embodiments, the determining a first node of the routing node in the first routing path may be implemented in the following manner: performing the following processing on each of the second nodes: determining the second node as the first node when the second node is the end point of the first routing path; determining the second node as the first node when a path distance between the second node and the end point of the first routing path is less than a path distance between the second node and the start point of the first routing path; and determining the second node as the first node when the path distance between the second node and the end point of the first routing path is equal to the path distance between the second node and the start point of the first routing path and a path distance between the routing node and the start point of the first routing path is less than a path distance between the routing node and the end point of the first routing path.

In some embodiments, the first node in each first routing path, for example, an initial routing node of each path, is determined. All received first routing paths are checked, to find the paths having the same first node. If at least two paths have the same first node, it indicates that these paths may jointly point to a potential faulty node. Any one of these paths having the same first node is selected as the first routing path. The remaining paths are defined as second routing paths, to facilitate subsequent fault diagnosis. For each of the second routing paths, it is checked whether the first node thereof is an end point of the path. If the first node is not the end point, it means that the node serves as an initial node in a plurality of paths, but does not complete a routing task thereof, and therefore is likely to be a faulty node.

In some embodiments, the path distance is configured for indicating a distance between two different path nodes in the first routing path in the first routing path.

As an example, when the first routing path is a node A-a node B-a node C-a node D-a node E and the routing node is the node C, second nodes of the node C are the node B and the node D. For the node D, when a path distance between the second node and the end point (the node E) of the first routing path is less than a path distance between the second node and the start point of the first routing path, the second node (the node D) is determined as the first node.

As an example, when the first routing path is the node A-the node B-the node C-the node D-the node E and the routing node is the node B, second nodes of the node B are the node A and the node C. For the node C, when a path distance between the second node (the node C) and the end point (the node E) of the first routing path is equal to a path distance between the second node (the node C) and the start point (the node A) of the first routing path, and a path distance between the second node (the node B) and the start point (the node A) of the first routing path is less than a path distance between the second node (the node B) and the end point (the node E) of the first routing path, the second node (the node C) is determined as the first node.

As an example, when the first routing path is the node A-the node B-the node C-the node D-the node E and the routing node is the node D, second nodes of the node B are the node C and the node E. For the node E, when the second node (the node E) is the end point of the first routing path, the second node (the node E) is determined as the first node.

In this way, after the first node in the first routing path is determined, first nodes in a plurality of paths are compared, and when it is found that at least two paths have the same first node, one of the paths is selected as the first routing path, and the remaining paths are selected as second routing paths, which can reduce misjudgment and centralize resources to detect a suspicious node. For each of the second routing paths, it is further checked whether the first node thereof is an end point, and if not, the node is marked as a faulty node. This policy not only helps to quickly locate a potential faulty node repeatedly appearing in different paths, but also reduces a quantity of paths needing to be further checked by distinguishing the first routing path from the second routing path, thereby optimizing a fault detection process. In addition, such a hierarchical fault determination method helps a network administrator allocate resources more effectively, reduces troubleshooting time, improves reliability and quality of service of the network, and ensures continuity and stability of a user service.

Operation 202: Receive a second routing path in response to the routing node being not a faulty first routing node and the faulty first routing node existing in the first routing path.

In some embodiments, the second routing path is different from the first routing path, and the second routing path does not include the faulty first routing node.

As an example, referring to FIG. 9, when the routing node is the routing node 414, the routing node 414 receives, in response to the routing node being not the faulty first routing node and the faulty first routing node existing in the first routing path, a second routing path transmitted by the service node 421.

As an example, referring to FIG. 10, when the routing node is the routing node 411, the routing node 411 receives, in response to the routing node being not the faulty first routing node and the faulty first routing node existing in the first routing path, a second routing path transmitted by the service node 414.

In some embodiments, referring to FIG. 13, FIG. 13 is a schematic flowchart V of a data routing method according to some embodiments. Operation 202 shown in FIG. 12 may be implemented by using operation 2021 to operation 2022 shown in FIG. 13.

Operation 2021: Receive a second routing packet carrying the second routing path.

In some embodiments, the second routing packet carries the second routing path and routing data.

As an example, referring to FIG. 9, when the routing node is the routing node 414, the routing node 414 receives the second routing packet carrying the second routing path.

Operation 2022: Perform path extraction on the second routing packet, to obtain the second routing path.

In some embodiments, since the second routing packet carries the second routing path, the second routing path may be directly extracted from the second routing packet.

In some embodiments, after operation 202 is performed, the second routing packet may be transmitted in the following manner: determining a third node of the routing node in the second routing path; and transmitting the second routing packet to the third node.

As an example, referring to FIG. 9, when the routing node is the routing node 414, the third node of the routing node 414 is the routing node 411, and then the routing node 414 may transmit the second routing packet to the routing node 411, so that the routing node 411 transmits the second routing packet to the routing node 415.

In some embodiments, the third node is the end point of the second routing path, or a path distance between the third node and the end point of the second routing path is less than or equal to a path distance between the third node and a start point of the second routing path.

In this way, the network system is allowed to parse and record a transmission path of the data on the second routing path in detail, thereby providing important transparency and visibility for network management. By using path extraction, the network administrator can clearly identify and detect each node through which data flows, which helps quickly locate a problem when a network fault or performance problem occurs. This further helps optimize a network design, because by analyzing the second routing path, the administrator can discover a potential bottleneck and an unnecessary route hop in the network, thereby adjusting a network structure to improve efficiency.

In some embodiments, the second routing path includes at least one second node in communication connection with the routing node, and the determining a third node of the routing node in the second routing path may be implemented in the following manner: performing the following processing on each of the second nodes: determining the second node as a third node when the second node is the end point of the first routing path; determining the second node as the third node when a path distance between the second node and the end point of the first routing path is less than a path distance between the second node and the start point of the first routing path; and determining the second node as the third node when the path distance between the second node and the end point of the first routing path is equal to the path distance between the second node and the start point of the first routing path and a path distance between the routing node and the start point of the first routing path is less than a path distance between the routing node and the end point of the first routing path.

As an example, when the second routing path is the node A-the node B-the node C-the node D-the node E and the routing node is the node C, second nodes of the node C are the node B and the node D. For the node D, when the path distance between the second node and the end point (the node E) of the second routing path is less than the path distance between the second node and the start point of the second routing path, the second node (the node D) is determined as the third node.

As an example, when the second routing path is the node A-the node B-the node C-the node D-the node E and the routing node is the node B, second nodes of the node B are the node A and the node C. For the node C, when a path distance between the second node (the node C) and the end point (the node E) of the second routing path is equal to a path distance between the second node (the node C) and the start point (the node A) of the second routing path, and a path distance between the second node (the node B) and the start point (the node A) of the second routing path is less than a path distance between the second node (the node B) and the end point (the node E) of the second routing path, the second node (the node C) is determined as the third node.

In this way, by determining the second node meeting a condition as the third node, the system can ensure that an optimal or sub-optimal path is selected from a plurality of possible routing paths, thereby avoiding an unnecessary data transmission delay and possible network congestion. When the second node is the end point of the first routing path, determining the second node as the third node can reduce a quantity of additional routing hops, thereby improving data transmission efficiency. When a distance between the second node and the end point is less than a distance between the second node and the start point, this processing helps to avoid a circuitous path and reduce transmission time. When the distances from the second node to the end point and to the start point are equal but a direct distance to the start point is shorter, determining the second node as the third node also helps to optimize path selection. Such a policy comprehensively considers a path length and a quantity of hops, so that the network can make more intelligent routing selections, which improves a data transmission speed and efficiency, and also facilitates load balancing and resource optimization of the network, thereby improving overall network performance and user experience.

As an example, when the second routing path is the node A-the node B-the node C-the node D-the node E and the routing node is the node D, second nodes of the node B are the node C and the node E. For the node E, when the second node (the node E) is the end point of the second routing path, the second node (the node E) is determined as the third node.

In this way, the routing node receives a first routing path, the first routing path includes a routing node configured to perform data routing, and in response to the routing node being not the faulty first routing node and the faulty first routing node existing in the first routing path, the routing node receives a second routing path, and performs data routing by using the second routing path, so as to ensure normal operation of data routing without being affected by the faulty first routing node, thereby effectively reducing an influence of a path fault on data routing.

Referring to FIG. 14, FIG. 14 is a schematic flowchart VI of a data routing method according to some embodiments. Descriptions are provided with reference to operation 301 to operation 303 shown in FIG. 14. The data routing method provided in some embodiments may be implemented solely by a server or a terminal, or implemented collaboratively by the server and the terminal. The following describes the data routing method implemented solely by the server and from the perspective of a management node.

Operation 301: Generate a first routing path taking a first service node as a start point, and transmit the first routing path to the first service node, the first routing path including at least one routing node configured to perform data routing.

In some embodiments, the management node transmits the first routing path to a service node (a first service node) corresponding to the start point of the first routing path, and the first routing path includes at least one routing node configured to perform data routing.

In some embodiments, the generating a first routing path taking a first service node as a start point may be implemented in the following manner: receiving a data routing request transmitted by the first service node, the data routing request carrying a second service node corresponding to an end point of the first routing path; generating at least one third routing path by taking the first service node as a start point and the second service node as an end point, routing nodes in different third routing paths being at least partially different; and determining the first routing path based on the third routing paths.

In some embodiments, the first service node and the second service node are located in the same distributed service system, and the generating at least one third routing path by taking the first service node as a start point and the second service node as an end point may be implemented in the following manner: acquiring routing nodes in the distributed service system in which the first service node and the second service node are located, and permutating the routing nodes, to obtain at least one fifth routing path, the fifth routing path including at least one routing node in the distributed service system; and performing the following processing respectively on each of the fifth routing paths: fusing the fifth routing path, the first service node, and the second service node in order of the first service node, the fifth routing path, and the second service node, to obtain the third routing path corresponding to the fifth routing path.

In some embodiments, the foregoing permutation refers to full permutation, which refers to a processing process of taking m (m is less than or equal to n) routing nodes from n different routing nodes and arranging the routing nodes in a order into a column to obtain a routing node path, for example, a processing process of taking m routing nodes from n routing nodes to obtain a routing node path.

As an example, a quantity of the routing node path is positively correlated with a quantity of routing nodes in the distributed service system, and an expression of the quantity of the routing node path may be:

$${S}_{1} = n ( n - 1 ) ( n - 2 ) … 3 \times 2 \times 1 = n ! \qquad ( 2 )$$

where S is configured for indicating the quantity of routing node paths, and n is configured for indicating the quantity of routing nodes in the distributed service system.

As an example, the first service node is the node A, the routing node path is {node B, node C, node D}, and the second service node is the node E. The routing node path, the first service node, and the second service node are fused in order of the first service node (the node A), the routing node path {node B, node C, node D}, and the second service node (the node E), to obtain a third routing path {node A, node B, node C, node D, node E} corresponding to the routing node path.

As an example, referring to FIG. 10, when the first service node is the service node 421 shown in FIG. 10, the management node 40 receives a data routing request transmitted by the service node 421, the data routing request carrying a second service node (for example, the service node 422 shown in FIG. 10) corresponding to the end point of the first routing path, and generates at least one third routing path by taking the first service node as a start point and the second service node as an end point, for example, a third routing path A (the service node 421, the routing node 414, the routing node 411, the routing node 415, and the service node 422), and a third routing path B (the service node 421, the routing node 414, and the service node 422); and determines the first routing path based on the third routing path A and the third routing path B.

In this way, the construction of the fifth routing path enables the system to identify a plurality of possible data transmission paths in the distributed service system, where each path includes at least one routing node in the system, which provides flexibility and redundancy for data transmission. Processing is performed on each fifth routing path, for example, the routing node path is fused with the first service node and the second service node, to generate the third routing path, which helps to optimize the data transmission process. According to this method, it can be ensured that data follows a clear and efficient path during transmission, and at the same time, the path can be dynamically adjusted according to a change in a network condition. This not only improves a data transmission speed and efficiency, but also enhances adaptability and robustness of the network, thereby facilitating implementation of better resource management and service continuity in a distributed environment.

In some embodiments, the determining the first routing path based on the third routing paths may be implemented in the following manner: determining, when one third routing path is provided, the third routing path as the second routing path; and determining, when a plurality of third routing paths are provided, the third routing path with the highest path transmission performance as the first routing path, or determining each of the third routing paths as the first routing path.

Following the foregoing example, path transmission performance of the third routing path A is higher than that of the third routing path B, and when a plurality of third routing paths are provided, the third routing path A with the highest path transmission performance is determined as the first routing path, or both the third routing path A and the third routing path B are determined as the first routing paths.

In this way, when one third routing path is provided, the third routing path is determined as the second routing path; and when a plurality of third routing paths are provided, the third routing path with the highest path transmission performance is determined as the first routing path, so that one first routing path is transmitted, thereby effectively saving an amount of data transmission of the first routing path and effectively improving routing efficiency.

In this way, when a plurality of third routing paths are provided, the third routing paths are all determined as the first routing paths, and the first routing paths are transmitted, so as to provide a receiver of the first routing path with a plurality of first routing paths as an alternative solution, thereby avoiding repeated requests for a path from the receiver of the first routing path, effectively saving a number of times of repeated transmission of the first routing path, and effectively improving routing efficiency.

As an example, referring to FIG. 9, when the service node corresponding to the start point of the first routing path is the service node 421, the management node 40 transmits at least one first routing path to the service node 421 corresponding to the start point of the first routing path, and start points of the first routing paths transmitted to the service node 421 are all the service node 421.

As an example, referring to FIG. 9, when the service node corresponding to the start point of the first routing path is the service node 422, the management node 40 transmits at least one first routing path to the service node 422 corresponding to the start point of the first routing path, and start points of the first routing paths transmitted to the service node 422 are all the service node 422.

Operation 302: Generate, in response to a path acquisition request transmitted by the first service node, a second routing path taking the first service node as a start point.

In some embodiments, the at least one routing node in operation 302 refers to a routing node in the first routing path. That is, in response to a faulty first routing node existing in the first routing path, the management node receives the path acquisition request. The path acquisition request is generated when the faulty first routing node exists in the at least one routing node.

In some embodiments, the generating a second routing path taking the first service node as a start point may be implemented in the following manner: acquiring second routing nodes in one-to-one correspondence to the faulty first routing nodes, the second routing nodes being not faulty and not belonging to the first routing path; and respectively updating the faulty first routing nodes in the first routing path to the corresponding second routing nodes, to obtain the second routing path.

In some embodiments, the one-to-one correspondence between the faulty first routing nodes and the second routing nodes means that one faulty first routing node corresponds to one second routing node, different faulty first routing nodes correspond to different second routing nodes, and different second routing nodes correspond to different faulty first routing nodes.

As an example, referring to FIG. 9, when the first routing path is: the service node 421-the routing node 414-the routing node 411-the routing node 415-the service node 422 and the faulty first routing node is the routing node 411, the faulty first routing node (the routing node 414) in the first routing path: the service node 421-the routing node 414-the routing node 411-the routing node 415-the service node 422, is updated to a corresponding second routing node (the routing node 412), to obtain the second routing path: the service node 421-the routing node 412-the routing node 411-the routing node 415-the service node 422.

As an example, referring to FIG. 10, when the first routing path is: the service node 421-the routing node 414-the service node 422 and the faulty first routing node is the routing node 414, the faulty first routing node (the routing node 414) in the first routing path: the service node 421-the routing node 414-the service node 422, is updated to the corresponding second routing node (the routing node 412), to obtain the second routing path: the service node 421-the routing node 412-the service node 422.

This ensures that when a node in the first routing path is faulty, alternative routing nodes, i.e., the second routing nodes, can be quickly found. These nodes are fault-free and do not belong to the original faulty first routing path, thereby avoiding conflicts and interference on the path. The faulty first routing node is updated to the corresponding second routing node, so that a routing path can be dynamically reconstructed, to form a second routing path, which greatly improves flexibility and robustness of the network. The timely routing node replacement mechanism can reduce service interruption time caused by a fault, maintain service continuity, and optimize user experience. In addition, the policy also facilitates load balancing of the network, because the policy can dynamically adjust a data transmission path according to a real-time network state, thereby improving utilization of network resources, reducing a risk of network congestion, and improving performance and reliability of the entire network.

In some other embodiments, the generating a second routing path taking the first service node as a start point may be implemented in the following manner: determining a second service node located at an end point of the first routing path; and regenerating, by taking the first service node as a start point and the second service node as an end point, the second routing path not including the faulty first routing node.

In some embodiments, the regenerating, by taking the first service node as a start point and the second service node as an end point, the second routing path not including the faulty first routing node may be implemented in the following manner: acquiring routing nodes in the distributed service system in which the first service node and the second service node are located, and determining the routing nodes in the distributed service system, other than the routing nodes including the faulty first routing node, as target routing nodes; permutating the target routing nodes, to obtain at least one target routing node path, where the target routing node path includes at least one target routing node in the distributed service system; and performing the following processing respectively on each of the target routing node paths: fusing the target routing node path, the first service node, and the second service node in order of the first service node, the target routing node path, and the second service node, to obtain the second routing path corresponding to the target routing node path.

In some embodiments, the foregoing permutation refers to full permutation, which refers to a processing process of taking m (m is less than or equal to n) target routing nodes from n different target routing nodes and arranging the target routing nodes in a order into a column to obtain a target routing node path, for example, a processing process of taking m target routing nodes from n target routing nodes to obtain a target routing node path.

As an example, a quantity of the target routing node path is positively correlated with a quantity of target routing nodes in the distributed service system, and an expression of the quantity of the target routing node path may be:

$${S}_{2} = t ( t - 1 ) ( t - 2 ) … 3 \times 2 \times 1 = t ! \qquad ( 3 )$$

where S₂ is configured for indicating the quantity of target routing node paths, and t is configured for indicating the quantity of target routing nodes in the distributed service system.

As an example, the first service node is the node A, the target routing node path is {node B, node C, node D}, and the second service node is the node E. The target routing node path, the first service node, and the second service node are fused in order of the first service node (the node A), the target routing node path {node B, node C, node D}, and the second service node (the node E), to obtain a second routing path {node A, node B, node C, node D, node E} corresponding to the target routing node path.

In this way, routing nodes in the distributed service system in which the first service node and the second service node are located are acquired, the routing nodes in the distributed service system other than the routing nodes including the faulty first routing node are determined as target routing nodes, and the target routing nodes are permutated, to obtain at least one target routing node path, so that the generated target routing node path effectively avoids the faulty first routing node. The target routing node path, the first service node, and the second service node are fused in order of the first service node, the target routing node path, and the second service node, to obtain the second routing path corresponding to the target routing node path, so that the generated second routing path has the same start point and end point as the first routing path and does not include the faulty first routing node, thereby enabling data routing to be performed by using the second routing path, which can ensure normal operation of data routing without being affected by the faulty first routing node, thereby effectively reducing an influence of a path fault on data routing.

As an example, referring to FIG. 10, when the first service node is the service node 421 shown in FIG. 10 and the faulty first routing node is the routing node 415, the management node 40 receives a data routing request transmitted by the service node 421, the data routing request carrying a second service node (for example, the service node 422 shown in FIG. 10) located at the end point of the first routing path, and regenerates the second routing path not including the faulty first routing node 415 by using the service node 421 as a start point and the service node 422 as an end point.

Operation 303: Transmit the second routing path to the first service node, the second routing path being different from the first routing path, and the second routing path not including the faulty first routing node.

In some embodiments, the management node transmits, to the first service node, the second routing path generated based on the path acquisition request.

Following the foregoing example, referring to FIG. 9, the management node 40 transmits, to the first service node 421, the second routing path generated based on the path acquisition request: the service node 421-the routing node 412-the routing node 411-the routing node 415-the service node 422.

In this way, the first service node receives a first routing path taking a first service node as a start point, transmits a path acquisition request in response to a faulty first routing node existing in at least one routing node, receives a second routing path returned based on the path acquisition request, and performs data routing based on the second routing path. In this way, when the faulty first routing node exists in the at least one routing node included in the first routing path, the second routing path not including the faulty first routing node is requested and obtained, and data routing is performed by using the second routing path, so as to ensure normal operation of data routing without being affected by the faulty first routing node, thereby effectively reducing an influence of a path fault on data routing.

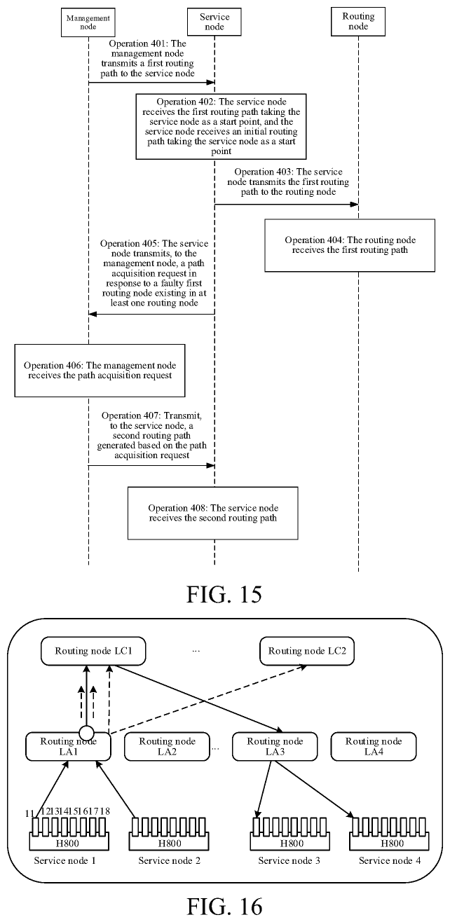

Referring to FIG. 15, FIG. 15 is a schematic flowchart VII of a data routing method according to some embodiments. Descriptions are provided with reference to operation 401 to operation 408 shown in FIG. 15. The data routing method provided in some embodiments may be implemented solely by a server or a terminal, or implemented collaboratively by the server and the terminal. The following describes the data routing method implemented solely by the server and from the perspective of a distributed service system.

Operation 401: The management node transmits a first routing path to the service node.

In some embodiments, the management node transmits the first routing path to the service node corresponding to a start point of the first routing path, and the first routing path includes at least one routing node configured to perform data routing.

Operation 402: The service node receives the first routing path taking the service node as a start point.

In some embodiments, the first routing path includes at least one routing node configured to perform data routing.

In some embodiments, the first service node is the start point of the first routing path, the first routing path includes a start point, an end point, and intermediate waypoints, the start point and the end point of the first routing path are service nodes, and the intermediate waypoints of the first routing path are routing nodes.

In some embodiments, the first routing path includes at least one routing node configured to perform data routing.

As an example, referring to FIG. 6, the first service node (the service node 421) receives a first routing path (for example, the first routing path is: the service node 421-the routing node 414-the routing node 411-the routing node 415-the service node 422) transmitted by the management node 40 and taking the first service node (the service node 421) as a start point.

Operation 403: The service node transmits the first routing path to the routing node.

As an example, the first service node (the service node 421) transmits the first routing path to the routing node 414.

Operation 404: The routing node receives the first routing path.

As an example, the routing node 414 receives the first routing path.

Operation 405: The service node transmits, to the management node, a path acquisition request in response to a faulty first routing node existing in at least one routing node.

In some embodiments, the at least one routing node refers to a routing node in the first routing path. That is, in response to a faulty first routing node existing in the at least one routing node means in response to a faulty first routing node existing in the first routing path.

As an example, referring to FIG. 9, when the first routing path is: the service node 421-the routing node 414-the routing node 411-the routing node 415-the service node 422, the first service node (the service node 421) responds to a faulty first routing node existing in the first routing path, and the first service node (the service node 421) transmits a path acquisition request to the management node 40.

In some embodiments, operation 405 may be implemented in the following manner: transmitting the path acquisition request in response to the faulty first routing node existing in the first routing path and one third routing path being provided. The path acquisition request is transmitted in response to the faulty first routing node existing in the first routing path, a plurality of third routing paths being provided, and the third routing paths other than the first routing path including the faulty first routing node.

Operation 406: The management node receives the path acquisition request.

In some embodiments, the management node receives the path acquisition request in response to the faulty first routing node existing in the at least one routing node.

In some embodiments, after the path acquisition request is received, the second routing path may be determined in the following manner: acquiring second routing nodes in one-to-one correspondence to the faulty first routing nodes, the second routing nodes being not faulty and not belonging to the first routing path; and respectively updating the faulty first routing nodes in the first routing path to the corresponding second routing nodes, to obtain the second routing path.

As an example, referring to FIG. 9, when the first routing path is: the service node 421-the routing node 414-the routing node 411-the routing node 415-the service node 422 and the faulty first routing node is the routing node 411, the faulty first routing node (the routing node 414) in the first routing path: the service node 421-the routing node 414-the routing node 411-the routing node 415-the service node 422, is updated to a corresponding second routing node (the routing node 412), to obtain the second routing path: the service node 421-the routing node 412-the routing node 411-the routing node 415-the service node 422.

As an example, referring to FIG. 10, when the first routing path is: the service node 421-the routing node 414-the service node 422 and the faulty first routing node is the routing node 414, the faulty first routing node (the routing node 414) in the first routing path: the service node 421-the routing node 414-the service node 422, is updated to a corresponding second routing node (the routing node 412), to obtain the second routing path: the service node 421-the routing node 412-the service node 422.

This ensures that the network can respond quickly when a fault occurs, maintaining continuity of data flow by replacing routing nodes and avoiding prolonged service interruption. A selection criterion for the second routing node is that the second routing node is not faulty and does not belong to the first routing path, thereby helping to bypass a problem region, reducing a risk of fault propagation, and ensuring normal transmission of data. The routing node update policy improves adaptability of a network, and can dynamically adjust a network structure without interrupting a service, thereby enhancing robustness and reliability of the network.

Operation 407: Transmit, to the service node, a second routing path generated based on the path acquisition request.

In some embodiments, the second routing path is different from the first routing path, and the second routing path does not include the faulty first routing node.

Following the foregoing example, referring to FIG. 9, the management node 40 transmits, to the first service node 421, the second routing path generated based on the path acquisition request: the service node 421-the routing node 412-the routing node 411-the routing node 415-the service node 422.

Operation 408: The service node receives the second routing path.

In some embodiments, the first service node receives the second routing path returned by the management node based on the path acquisition request.

As an example, referring to FIG. 9 and FIG. 10, when the first service node is the service node 421, the service node 421 receives the second routing path returned by the management node 40 based on the path acquisition request.

In this way, the first service node receives a first routing path taking a first service node as a start point, transmits a path acquisition request in response to a faulty first routing node existing in at least one routing node, receives a second routing path returned based on the path acquisition request, and performs data routing based on the second routing path. In this way, when the faulty first routing node exists in the at least one routing node included in the first routing path, the second routing path not including the faulty first routing node is requested and obtained, and data routing is performed by using the second routing path, so as to ensure normal operation of data routing without being affected by the faulty first routing node, thereby effectively reducing an influence of a path fault on data routing.

An exemplary application of some embodiments in an actual application scenario of large model training will be described below.

An AI large model network is typically characterized by complex networking, complex traffic, and local congestion. A 4K-card cluster has more than 150 network devices and more than 10000 network links, while a 16K-card cluster has more than 1000 network devices and more than 50000 network links. In such complex networking, absolute network load balancing cannot be achieved by planning, making local load imbalance and link congestion almost inevitable.

In some embodiments, a network is segmented and a packet path is programmed on an end side (an HPN controller), thereby achieving an advantage that an intermediate node on a network side is unaware of a path state. This is intended to resolve problems of congestion and fault recovery in an AI training network. In some embodiments, by using the SRv6 technology, the network can be segmented more efficiently, and the packet path is programmed on the end side, thereby implementing flexible control and management on network traffic. This not only improves network performance and throughput, but also can effectively deal with network congestion and fault situations, thereby improving reliability and stability of the AI training network. Some embodiments discloses packet forwarding based on an SRv6-TE path and a packet forwarding manner. A control module pre-installs an SPT default route, an SPT node route, and an SRv6-TE forwarding path into a forwarding module. Based on the above, the forwarding module receives an SRv6 traffic packet carrying the SRv6-TE forwarding path, and parses the SRv6-TE forwarding path, to obtain a plurality of segment list members. Based on the foregoing method, the forwarding module parses a current segmented list member to obtain an SRv6 domain identifier of a current SRv6 domain and a next waypoint, and forms an IPv6 destination address according to the SRv6 domain identifier and the next waypoint. In some embodiments, the SRv6-TE forwarding path is formed by using the SRv6 domain identifier, an SRv6 node identifier, and an SRv6 adjacency identifier that represent a topology, which can improve path compression efficiency of SRv6 SRH and reduce a packet redundancy rate without affecting a network scale.

A network topology of the AI large model is complex, and whether a route or a source port number of a flow is modified, a Hash algorithm of a switch is a black box, and it is difficult to accurately calculate a new path. Therefore, it is difficult to ensure a control effect. Some heuristic or speculative evaluation methods in academia are difficult to be effective in actual production. This difficulty is also one of core challenges of AI network traffic scheduling. In some embodiments, to resolve the problem of accuracy of ECMP hash, a transmission path is segmented on an end side by using an SRv6 segment routing technology, and then segments are combined, to implement link congestion avoidance and fault recovery of an RDMA network.

In some embodiments, referring to FIG. 18, FIG. 18 is a schematic diagram V of a principle of a data routing method according to some embodiments. The data routing method provided in some embodiments may be implemented by using a distributed service system shown in FIG. 18. The distributed service system includes nodes (for example, the service nodes described above) (e.g., the service node A, the service node B, the service node C, and the service node D shown in FIG. 18), LA/LC (for example, the routing nodes described above) (e.g., the routing node 1, the routing node 2, the routing node, the routing node 9, the routing node 10, the routing node 1, and the routing node 2 shown in FIG. 18), and an HPN controller (for example, the management node described above). A service node includes at least one service interface. For example, the service node A shown in FIG. 18 includes a service interface 1, a service interface 2, a service interface 3, and a service interface 4.

In some embodiments, referring to FIG. 19, FIG. 19 is a schematic diagram VI of a principle of a data routing method according to some embodiments. A GPU_A (a source end, a port mounted on a node) and a GPU_B (a target end, a port mounted on a node) perform aggregation communication based on an RDMA protocol. The source end segments a network at the source end based on a path calculated by an HPN controller (a first routing path transmitted by an HPN received by the source end), and performs path combination (the segmented path combination herein refers to operation 2 to operation 4, i.e., a process in which the source end performs path finding (data routing) according to the received first routing path). The source end finds, based on Segment List (for example, the routing path described above) and Segments Left (3) in an IPv6 SRH header, that the next hop is an LA1 switch. The LA1 switch finds, based on Segment List and Segments Left (2) in the IPv6 SRH header, that the next hop is an LC1 switch. The LC1 switch finds, based on Segment List and Segments Left (1) in the IPv6 SRH header, that the next hop is an LA2 switch. The LA2 switch finds, based on Segment List and Segments Left (0) in the IPv6 SRH header, that the next hop is a GPU_B server.

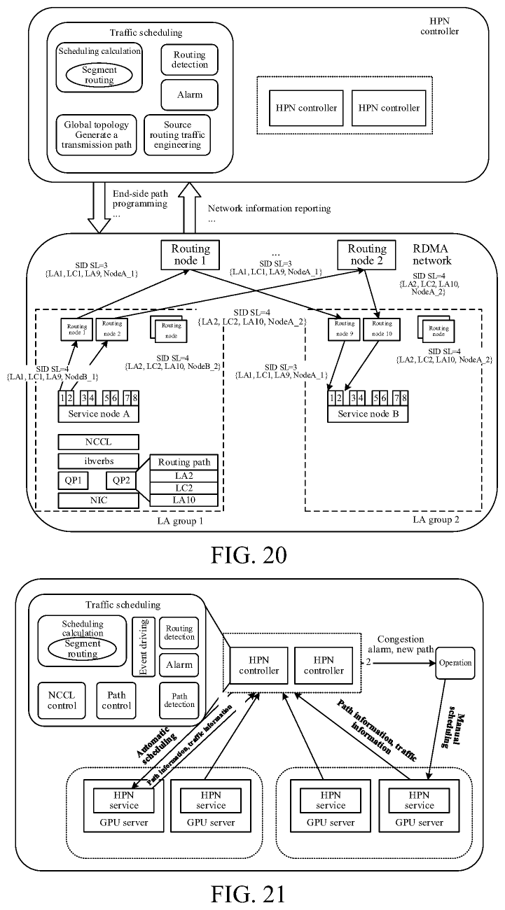

In some embodiments, referring to FIG. 20, FIG. 20 is a schematic diagram VII of a principle of a data routing method according to some embodiments. In some embodiments, source routing-traffic engineering capabilities may be implemented based on end-side routing segmentation and orchestration, traffic between different GPU cards may be distributed and offloaded to different transmission paths, maximizing utilization of an RDMA network bandwidth and preventing network congestion, and the HPN controller may precisely customize a transmission path between each pair of QPs according to an RDMA network topology, thereby maximizing utilization of the network bandwidth and minimizing congestion. A implementation is as follows: the HPN controller acquires a global RDMA network topology from an operation platform; the HPN controller calculates that a transmission path between NODE_A_1 and NODE_B_1 as a routing path (segment list): LA1, LC1, LA9, NODE_B_1; the HPN controller calculates a transmission path between NODE_A_2 to NODE_B_2 as a routing path (LA2, LC2, LA10, NODE_B_2); the HPN controller delivers generated path information to a training container NODE_A; and the NODE_A modifies a transmission path of QP1 and QP2, and adds a Segment List attribute to the QPs, so that a packet carries an SRv6 header when transmitted, thereby achieving precise navigation along the transmission path. A logical channel for communication between two nodes (QP) is a concept in InfiniBand and RDMA technologies, which represents a logical channel for communication between two nodes. Each QP includes a Send Queue and a Receive Queue, and is configured for transmitting and receiving data between two nodes.

In some embodiments, referring to FIG. 16, the problem of congestion encountered by the RDMA network is resolved based on end-side routing segmentation and orchestration, which can resolve uplink congestion from LA to LC. The congestion problem is as follows: RDMA packets transmitted by two servers arrive at the same switch (LA1), and the LA1 switch (for example, the routing node LA1) performs ECMP Hash on two flows to the same upstream switch (LC1, for example, the routing node LC1), causing upstream congestion on the LA1 switch. A implementation is as follows: the HPN controller receives a traffic congestion alarm report; the HPN controller recalculates and re-orchestrates a transmission path from the service node 2 to the service node 4, which is re-orchestrated from an original routing path (the routing node LA1, the routing node LC1, and the routing node LA1) into a routing path (the routing node LA1, the routing node LC2, and the routing node LA1); the HPN controller delivers the new routing path to an HPN service of the service node 2, and modifies an SRv6 header of a packet by using a NVIDIA collective communications library (NCCL); and the transmission path from the service node 2 to the service node 4 is modified from the routing node LC1 into the routing node LC2, which resolves the problem of uplink congestion from LA to LC.

In some embodiments, referring to FIG. 17, downlink congestion caused by the problem of Hash polarization from LC to LA is resolved based on end-side routing segmentation and orchestration. The congestion problem is as follows: traffic of two GPU servers is from two LAN switches, and from LA to LC, due to the problem of ECMP Hash, the traffic is offloaded to the same LC, causing downlink congestion from LC to LA. A implementation is as follows: the HPN controller receives a traffic congestion alarm report; the HPN controller recalculates and re-orchestrates a transmission path from the service node 2 to the service node 4, which is re-orchestrated from an original routing path (LA2, LC1, LA1, NODE4) into a routing path (the routing node LA2, the routing node LC2, the routing node LA1, the service node 4); the HPN controller delivers a new Segment List to hpn_agent of the service node 2, and an HPN service of the service node 2 modifies an SRv6 header of a packet by using a library configured for accelerating data transmission between a plurality of GPUs (NCCL); and the transmission path from Node2 to Node4 is modified from the routing node LC1 into the routing node LC2, which resolves the problem of downlink congestion from LC to LA.

In some embodiments, referring to FIG. 21, FIG. 21 is a schematic diagram VIII of a principle of a data routing method according to some embodiments. In some embodiments, source-end routing may be automatically or manually re-orchestrated based on end-network collaboration. A implementation is as follows: an HPN service reports content such as priority flow control (PFC), an explicit congestion notification (ECN), and a transmission path to the HPN controller; after receiving information such as path traffic, the HPN controller transfers a calculated new path (path information and traffic information) to an operation platform, then the operation platform delivers the calculated new path to a graphics processing unit server (GPU server) through manual scheduling, and upon receipt, a Segment List corresponding to a QP is modified; after receiving information such as path traffic, the HPN controller delivers the calculated new path to the GPU server through automatic scheduling, and modifies a routing path corresponding to the QP after receiving the new path; and after updating the Segment List of the QP, the GPU server may bypass a congested link node.

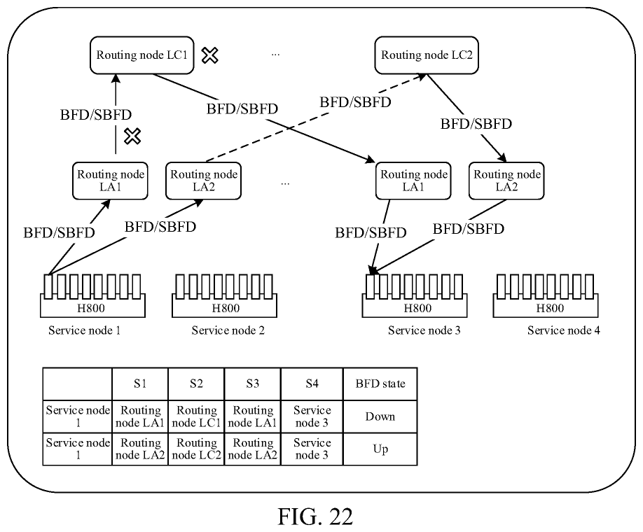

In some embodiments, referring to FIG. 22, FIG. 22 is a diagram IX of a principle of a data routing method according to some embodiments. In some embodiments, rapid fault perception, self-healing, and dynamic traffic scheduling in an RDMA network may be resolved based on end-network collaboration. A implementation is as follows: the service node 1 orchestrates a transmission path from the service node 1 to the service node 3 at an end side; bfd or sbfd detection is established between two transmission paths of the service node 1 and the service node 3; an initial routing path from the service node 1 to the service node 3 is {the routing node LA1, the routing node LC1, the routing node LA1, the service node 3}; when a link fault occurs, for example, when the routing node LC1 fails, bfd on the service node 1 may perceive the link fault; and the service node 1 re-orchestrates a transmission path, and modifies the transmission path into a routing path {the routing node LA2, the routing node LC2, the routing node LA2, the service node 3}. Herein, the node1 may receive a first routing path {the routing node LA1, the routing node LC1, the routing node LA1, the service node 3} and at least zero alternate path that are transmitted by the HPN controller. For example, in addition to receiving {the routing node LA1, the routing node LC1, the routing node LA1, the service node 3}, the node1 further receives {the routing node LA2, the routing node LC2, the routing node LA2, the service node 3}. When {the routing node LA1, the routing node LC1, the routing node LA1, the service node 3} fails, the node1 may directly switch to {the routing node LA2, the routing node LC2, the routing node LA2, the service node 3}. The HPN controller recalculates and re-orchestrates the transmission path from the service node 2 to the service node 4, which is re-orchestrated from an original routing path (the routing node LA2, the routing node LC1, the routing node LA1, the service node 4) into a routing path (the routing node LA2, the routing node LC2, the routing node LA1, the service node 4). The HPN service on the service node 1 reports link state information to the HPN controller.

In this way, in some embodiments, congestion of the RDMA network can be resolved, efficiency of training of the large AI model can be improved, and a proportion of time occupied by network transmission in an entire training process can be reduced.

During the application of some embodiments in products or technologies, relevant data involving in the first routing path in some embodiments needs permission or consent of the user, and the collection, use, and processing of relevant data need to comply with relevant laws, regulations, and standards of relevant countries and districts.

The following continues to describe an exemplary structure in which the data routing apparatus 455 provided in some embodiments is implemented as a software module. In some embodiments, as shown in FIG. 2, the software module in the data routing apparatus 455 stored in the memory 450 may include: an initial receiving module 4551, configured to receive a first routing path taking the first service node as a start point, the first routing path including at least one routing node configured to perform data routing; a service response module 4552, configured to transmit a path acquisition request in response to a faulty first routing node existing in the at least one routing node; a target receiving module 4553, configured to receive a second routing path returned based on the path acquisition request, the second routing path being different from the first routing path, and the second routing path not including the first routing node; and a data routing module 4554, configured to perform data routing according to the second routing path.

In some embodiments, the initial receiving module is further configured to receive at least one third routing path taking the first service node as a start point, the third routing path including at least one routing node configured to perform data routing; determine, when one third routing path is received, the third routing path as the first routing path; and acquire, when a plurality of third routing paths are received, path transmission performance of the third routing paths, and determine the third routing path with the highest path transmission performance as the first routing path.

In some embodiments, the initial receiving module is further configured to transmit the path acquisition request in response to the first routing node existing in the first routing path and one third routing path being provided; and transmit the path acquisition request in response to the first routing node existing in the first routing path, a plurality of third routing paths being provided, and the third routing paths other than the first routing path including the first routing node.

In some embodiments, the service response module is further configured to select, in response to the first routing node existing in the first routing path, a plurality of third routing paths being provided, and the third routing paths other than the first routing path not including the first routing node, one third routing path not including the first routing node from the third routing paths other than the first routing path as the second routing path.

In some embodiments, the service response module is further configured to determine, when two third routing paths are provided and the third routing path other than the first routing path does not include the first routing node, the third routing path other than the first routing path as the second routing path; and determine, when more than two third routing paths are provided, the third routing paths not including the first routing node in the third routing paths other than the first routing path as fourth routing paths, and determine the second routing path based on the fourth routing paths.

In some embodiments, the service response module is further configured to determine, when one fourth routing path is provided, the fourth routing path as the second routing path; and determine, when a plurality of fourth routing paths are provided, the fourth routing path with the highest path transmission performance as the second routing path.

In some embodiments, the service response module is further configured to perform path detection on the first routing path to obtain a path detection result; where the path detection result is configured for indicating whether the first routing node exists in the at least one routing node included in the first routing path.

In some embodiments, the service response module is further configured to determine a routing node that is in the first routing path and adjacent to the first service node as a third routing node; transmit, to the third routing node, a path detection packet carrying the first routing path, and receiving feedback information returned by the third routing node based on the path detection packet; determine the path detection result as a first detection result when the feedback information indicates that the path detection packet is capable of detecting a second service node; where the first detection result is configured for indicating that the first routing node does not exist in the at least one routing node included in the first routing path; and determine the path detection result as a second detection result when the feedback information indicates that the path detection packet is incapable of detecting the second service node; where the second detection result is configured for indicating that the first routing node exists in the at least one routing node included in the first routing path, and the second service node is a service node located at an end point of the first routing path.

In some embodiments, the service response module is further configured to acquire routing data in response to a data routing instruction; and perform, in response to the first routing node not existing in the at least one routing node, data routing based on the routing data and according to the first routing path; and the data routing module is further configured to perform data routing based on the routing data and according to the second routing path.

In some embodiments, the data routing module is further configured to determine a routing node that is in the first routing path and adjacent to the first service node as a third routing node; and perform packet fusion on the routing data and the first routing path, to obtain a first routing packet, and transmit the first routing packet to the third routing node.

In some embodiments, the data routing module is further configured to determine a routing node that is in the second routing path and adjacent to the first service node as a second routing node; and perform packet fusion on the routing data and the second routing path, to obtain a second routing packet, and transmit the second routing packet to the second routing node.

In some embodiments, the service response module is further configured to acquire routing data in response to a data routing instruction, and perform packet fusion on the routing data and the first routing path, to obtain a first routing packet; and determine a routing node that is in the first routing path and adjacent to the first service node as a third routing node, and transmit the first routing packet to the third routing node.

In some embodiments, the service response module is further configured to determine path information of the first routing path as target path information in response to fault information transmitted by a routing node in the first routing path; where the target path information is configured for indicating that the first routing node exists in the at least one routing node included in the first routing path.

In some embodiments, the data routing module is further configured to update the first routing path in the first routing packet to the second routing path, to obtain a second routing packet; and determine a routing node that is in the second routing path and adjacent to the first service node as a second routing node, and transmit the second routing packet to the second routing node.

In some embodiments, the data routing module is further configured to acquire routing data in response to a data routing instruction, and perform packet fusion on the routing data and the first routing path, to obtain a first routing packet; and determine a routing node that is in the first routing path and adjacent to the first service node as a third routing node, and transmit the first routing packet to the third routing node.

In some embodiments, the data routing module is further configured to determine path information of the first routing path as target path information in response to fault information transmitted by a routing node in the first routing path; where the target path information is configured for indicating that the first routing node exists in the at least one routing node included in the first routing path.

In some embodiments, the data routing module is further configured to update the first routing path in the first routing packet to the second routing path, to obtain a second routing packet; and determine a routing node that is in the second routing path and adjacent to the first service node as a second routing node, and transmit the second routing packet to the second routing node.

The following continues to describe an exemplary structure in which the data routing apparatus 555 provided in some embodiments is implemented as a software module. In some embodiments, as shown in FIG. 3, the software module in the data routing apparatus 555 stored in the memory 550 may include: a first receiving module 5551, configured to receive a first routing path, the first routing path including the routing node configured to perform data routing; and a second receiving module 5552, configured to receive a second routing path in response to the routing node being not a faulty first routing node and the first routing node existing in the first routing path; the second routing path being different from the first routing path, and the second routing path not including the first routing node.

In some embodiments, the first receiving module is further configured to determine, when at least two first routing paths are received, for each of the first routing paths, a first node of the routing node in the first routing path; where the first node is an end point of the first routing path, or a path distance between the first node and the end point of the first routing path is less than or equal to a path distance between the first node and a start point of the first routing path; and determine, when at least two identical first nodes exist in the received first routing paths, the routing node as the first routing node.

In some embodiments, the first receiving module is further configured to determine, when at least two identical first nodes exist in the received first routing paths, any one of the received first routing paths as the first routing path; determine the first routing paths other than the first routing path as second routing paths; and determine, for each of the second routing paths, the first node in the second routing path as the first routing node when the first node in the second routing path is not an end point of the second routing path.

In some embodiments, the first receiving module is further configured to perform the following processing on each of the second nodes: determining the second node as the first node when the second node is the end point of the first routing path; determining the second node as the first node when a path distance between the second node and the end point of the first routing path is less than a path distance between the second node and the start point of the first routing path; and determining the second node as the first node when the path distance between the second node and the end point of the first routing path is equal to the path distance between the second node and the start point of the first routing path and a path distance between the routing node and the start point of the first routing path is less than a path distance between the routing node and the end point of the first routing path.

In some embodiments, the second receiving module is further configured to receive a second routing packet carrying the second routing path, and perform path extraction on the second routing packet, to obtain the second routing path; and the second receiving module is further configured to determine a third node of the routing node in the second routing path; where the third node is the end point of the second routing path, or a path distance between the third node and the end point of the second routing path is less than or equal to a path distance between the third node and a start point of the second routing path; and transmit the second routing packet to the third node.

The following continues to describe an exemplary structure in which the data routing apparatus 666 provided in some embodiments is implemented as a software module. In some embodiments, as shown in FIG. 4, the software module in the data routing apparatus 666 stored in the memory 660 may include: an initial transmission module 6661, configured to generate a first routing path taking a first service node as a start point, and transmit the first routing path to the first service node, the first routing path including at least one routing node configured to perform data routing; a request receiving module 6662, configured to generate, in response to a path acquisition request transmitted by the first service node, a second routing path taking the first service node as a start point, the path acquisition request being generated when a faulty first routing node exists in the at least one routing node; and a target transmission module 6663, configured to transmit the second routing path to the first service node, the second routing path being different from the first routing path, and the second routing path not including the first routing node.

In some embodiments, the request receiving module is further configured to acquire second routing nodes in one-to-one correspondence to the faulty first routing nodes, the second routing nodes being not faulty and not belonging to the first routing path; and respectively update the faulty first routing nodes in the first routing path to the corresponding second routing nodes, to obtain the second routing path.

In some other embodiments, the request receiving module is further configured to determine a second service node located at an end point of the first routing path; and regenerate, by taking the first service node as a start point and the second service node as an end point, the second routing path not including the faulty first routing node.

In some embodiments, the initial transmission module is configured to receive a data routing request transmitted by the first service node, the data routing request carrying the second service node located at the end point of the first routing path; generate at least one third routing path by taking the first service node as a start point and the second service node as an end point, routing nodes in different third routing paths being at least partially different; and determine the first routing path based on the third routing paths.

In some embodiments, the initial transmission module is configured to determine, when one third routing path is provided, the third routing path as the second routing path; and determine, when a plurality of third routing paths are provided, the third routing path with the highest path transmission performance as the first routing path, or determine each of the third routing paths as the first routing path.

The following continues to describe an exemplary structure in which the data routing apparatus 766 provided in some embodiments is implemented as a software module. In some embodiments, as shown in FIG. 5, the software module in the data routing apparatus 766 stored in the memory 760 may include: an initial path module 7771, configured to transmit, by the management node, a first routing path to the service nodes, and receive, by the service nodes, the first routing path taking the service nodes as a start point, the first routing path including at least one routing node configured to perform data routing; and transmit, by the service nodes, the first routing path to the routing nodes, and receive, by the routing nodes, the first routing path; a path request module 7772, configured to transmit, by the service nodes, a path acquisition request to the management node in response to a faulty first routing node existing in the at least one routing node; and receive, by the management node, the path acquisition request, and transmit, to the service nodes, a second routing path generated based on the path acquisition request; the second routing path being different from the first routing path, and the second routing path not including the first routing node; and a target path module 7773, configured to receive, by the service nodes, the second routing path.

Some embodiments provides a computer program product. The computer program product includes a computer program or a computer-executable instruction. The computer program or the computer-executable instruction is stored in a computer-readable storage medium. A processor of an electronic device reads the computer-executable instruction from the computer-readable storage medium, and the processor executes the computer-executable instruction, to cause the electronic device to perform the data routing method according to some embodiments.

Some embodiments provides a computer-readable storage medium, having a computer-executable instruction stored therein. When the computer-executable instruction is executed by a processor, the processor is caused to perform the data routing method provided in some embodiments, for example, the data routing method as shown in FIG. 7.

In some embodiments, the computer-readable storage medium may be a memory such as a ROM, a RAM, an erasable programmable read-only memory (EPROM), a flash memory, a magnetic surface memory, an optical disk, or a CD-ROM, and may be various electronic devices including one of the foregoing memories or any combination thereof.

In some embodiments, the computer-executable instruction may be written in the form of a program, software, a software module, a script, or code in any form of programming language (including a compilation or interpretation language, or a declarative or procedural language), and the computer-executable instruction may be deployed in any form, including being deployed as an independent program or being deployed as a module, a component, a subroutine, or another unit suitable for use in a computing environment.

In an example, the computer-executable instruction may, but do not necessarily, correspond to a file in a file system, and may be stored in part of a file that saves another program or other data, for example, be stored in one or more scripts in a HyperText Markup Language (HTML) file, stored in a file that is specially configured for a program in discussion, or stored in a plurality of collaborative files (for example, be stored in files of one or more modules, subprograms, or code parts).

In some embodiments, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be part of an overall module or unit including a function of the module or unit.

As an example, the computer-executable instruction may be deployed to be executed on one electronic device, on a plurality of electronic devices located at one site, or on a plurality of electronic devices distributed at a plurality of locations and connected by a communication network.

In summary, some embodiments have the following beneficial effects:
(1) The first service node receives a first routing path taking a first service node as a start point, transmits a path acquisition request in response to a faulty first routing node existing in at least one routing node, receives a second routing path returned based on the path acquisition request, and performs data routing based on the second routing path. In this way, when the faulty first routing node exists in the at least one routing node included in the first routing path, the second routing path not including the faulty first routing node is requested and obtained, and data routing is performed by using the second routing path, so as to ensure normal operation of data routing without being affected by the faulty first routing node, thereby effectively reducing an influence of a path fault on data routing.
(2) At least one third routing path taking the first service node as a start point is received, and the third routing path with the highest path transmission performance is selected from the third routing paths as the first routing path, to preferentially select the third routing path with the highest path transmission performance for data routing, thereby effectively improving routing efficiency of data routing.
(3) When the faulty first routing node already exists in the first routing path, it indicates that data routing cannot be performed on the first routing path. When a plurality of third routing paths are received by the first service node, one third routing path not including the faulty first routing node may be directly selected from the third routing paths other than the first routing path as the second routing path, so that when the faulty first routing node exists in the first routing path, the first service node directly searches the routing node locally for one third routing path not including the faulty first routing node as the second routing path. Therefore, the first service node does not need to request the second routing path again from the side of the management node, so that the second routing path not including the faulty first routing node can be rapidly found when the first routing path fails, thereby effectively saving a duration of fault repair and effectively improving fault avoidance efficiency.
(4) The path detection packet carries the first routing path, and the path detection packet does not carry routing data, thereby effectively reducing transmission time of the path detection packet, improving detection efficiency of path detection, and enabling rapid determination of the faulty first routing node in the first routing path.
(5) Since it has been determined, before data routing is performed based on the routing data and according to the first routing path, that the faulty first routing node does not exist in the first routing path, packet fusion may be performed on the routing data and the first routing path, to obtain a first routing packet, and the first routing packet is transmitted to the first routing node, thereby implementing routing of the routing data to the end point of the first routing path (the second routing node) according to the first routing path and accurately implementing data routing based on the first routing path.
(6) Since the first routing packet carries the first routing path and the first routing packet carries the routing data, in the process of performing data routing by using the first routing packet, path detection can also be implemented. When the faulty first routing node does not exist in the first routing path, time consumption caused by path detection can be effectively avoided, thereby effectively improving routing efficiency of data routing.
(7) The path acquisition request is transmitted in response to the faulty first routing node existing in the first routing path and one third routing path being provided, or the path acquisition request is transmitted in response to the faulty first routing node existing in the first routing path, a plurality of third routing paths being provided, and the third routing paths other than the first routing path including the faulty first routing node, so that the first service node may request the second routing path from the management node only when third routing paths not including the faulty first routing node are not locally stored in the first service node, thereby effectively reducing a frequency of requests for the second routing path from the management node, effectively saving a duration of fault repair, and effectively improving fault avoidance efficiency.
(8) The routing node receives a first routing path, the first routing path includes a routing node configured to perform data routing, and in response to the routing node being not the faulty first routing node and the faulty first routing node existing in the first routing path, the routing node receives a second routing path, and performs data routing by using the second routing path, so as to ensure normal operation of data routing without being affected by the faulty first routing node, thereby effectively reducing an influence of a path fault on data routing.
(9) The third routing path taking the first service node as a start point is transmitted to the first service node, and the first service node directly determines the received third routing path as the first routing path, thereby significantly improving transmission efficiency of the first routing path.
(10) A plurality of third routing paths taking the first service node as a start point are transmitted to the first service node, and the first service node determines the third routing path with the highest path transmission performance as the first routing path, so that the plurality of third routing paths taking the first service node as the start point may be backed up in the first service node, and when a routing node fails in the first routing path, rapid path switching can be implemented, which can ensure normal operation of data routing without being affected by the faulty first routing node. Therefore, an influence of a path fault on data routing can be quickly reduced, thereby effectively improving fault avoidance efficiency of the first service node.
(11) The management node generates a first routing path taking the first service node as a start point, and transmits the first routing path, the first routing path including at least one routing node configured to perform data routing; and generates, in response to a received path acquisition request, a second routing path taking the first service node as a start point when a faulty first routing node exists in the at least one routing node, and transmits the second routing path. In this way, since the second routing path is different from the first routing path and the second routing path does not include the faulty first routing node, data routing is performed by generating the second routing path not including the faulty first routing node, which can ensure normal operation of data routing without being affected by the faulty first routing node, thereby effectively reducing an influence of a path fault on data routing.
(12) When one third routing path is provided, the third routing path is determined as the second routing path; and when a plurality of third routing paths are provided, the third routing path with the highest path transmission performance is determined as the first routing path, so that one first routing path is transmitted, thereby effectively saving an amount of data transmission of the first routing path and effectively improving routing efficiency.
(13) When a plurality of third routing paths are provided, the third routing paths are all determined as the first routing paths, and the first routing paths are transmitted, so as to provide a receiver of the first routing path with a plurality of first routing paths as an alternative solution, thereby avoiding repeated requests for a path from the receiver of the first routing path, effectively saving a number of times of repeated transmission of the first routing path, and effectively improving routing efficiency.
(14) Routing nodes in the distributed service system in which the first service node and the second service node are located are acquired, the routing nodes in the distributed service system other than the routing nodes including the faulty first routing node are determined as target routing nodes, and the target routing nodes are permutated, to obtain at least one target routing node path, so that the generated target routing node path effectively avoids the faulty first routing node. The target routing node path, the first service node, and the second service node are fused in order of the first service node, the target routing node path, and the second service node, to obtain the second routing path corresponding to the target routing node path, so that the generated second routing path has the same start point and end point as the first routing path and does not include the faulty first routing node, thereby enabling data routing to be performed by using the second routing path, which can ensure normal operation of data routing without being affected by the faulty first routing node, thereby effectively reducing an influence of a path fault on data routing.
(15) This ensures that the network can respond quickly when a fault occurs, maintaining continuity of data flow by replacing routing nodes and avoiding prolonged service interruption. A selection criterion for the second routing node is that the second routing node is not faulty and does not belong to the first routing path, thereby helping to bypass a problem region, reducing a risk of fault propagation, and ensuring normal transmission of data. The routing node update policy improves adaptability of a network, and can dynamically adjust a network structure without interrupting a service, thereby enhancing robustness and reliability of the network.
(16) This ensures that when a node in the first routing path is faulty, alternative routing nodes, i.e., the second routing nodes, can be quickly found. These nodes are fault-free and do not belong to the original faulty first routing path, thereby avoiding conflicts and interference on the path. The faulty first routing node is updated to the corresponding second routing node, so that a routing path can be dynamically reconstructed, to form a second routing path, which greatly improves flexibility and robustness of the network. The timely routing node replacement mechanism can reduce service interruption time caused by a fault, maintain service continuity, and optimize user experience. In addition, the policy also facilitates load balancing of the network, because the policy can dynamically adjust a data transmission path according to a real-time network state, thereby improving utilization of network resources, reducing a risk of network congestion, and improving performance and reliability of the entire network.
(17) The construction of the fifth routing path enables the system to identify a plurality of possible data transmission paths in the distributed service system, where each path includes at least one routing node in the system, which provides flexibility and redundancy for data transmission. Processing is performed on each fifth routing path, for example, the routing node path is fused with the first service node and the second service node, to generate the third routing path, which helps to optimize the data transmission process. According to this method, it can be ensured that data follows a clear and efficient path during transmission, and at the same time, the path can be dynamically adjusted according to a change in a network condition. This not only improves a data transmission speed and efficiency, but also enhances adaptability and robustness of the network, thereby facilitating implementation of better resource management and service continuity in a distributed environment.
(18) By determining the second node meeting a condition as the third node, the system can ensure that an optimal or sub-optimal path is selected from a plurality of possible routing paths, thereby avoiding an unnecessary data transmission delay and possible network congestion. When the second node is the end point of the first routing path, determining the second node as the third node can reduce a quantity of additional routing hops, thereby improving data transmission efficiency. When a distance between the second node and the end point is less than a distance between the second node and the start point, this processing helps to avoid a circuitous path and reduce transmission time. When the distances from the second node to the end point and to the start point are equal but a direct distance to the start point is shorter, determining the second node as the third node also helps to optimize path selection. Such a policy comprehensively considers a path length and a quantity of hops, so that the network can make more intelligent routing selections, which improves a data transmission speed and efficiency, and also facilitates load balancing and resource optimization of the network, thereby improving overall network performance and user experience.
(19) The network system is allowed to parse and record a transmission path of the data on the second routing path in detail, thereby providing important transparency and visibility for network management. By using path extraction, the network administrator can clearly identify and detect each node through which data flows, which helps quickly locate a problem when a network fault or performance problem occurs. This further helps optimize a network design, because by analyzing the second routing path, the administrator can discover a potential bottleneck and an unnecessary route hop in the network, thereby adjusting a network structure to improve efficiency.
(20) After the first node in the first routing path is determined, first nodes in a plurality of paths are compared, and when it is found that at least two paths have the same first node, one of the paths is selected as the first routing path, and the remaining paths are selected as second routing paths, which can reduce misjudgment and centralize resources to detect a suspicious node. For each of the second routing paths, it is further checked whether the first node thereof is an end point, and if not, the node is marked as a faulty node. This policy not only helps to quickly locate a potential faulty node repeatedly appearing in different paths, but also reduces a quantity of paths needing to be further checked by distinguishing the first routing path from the second routing path, thereby optimizing a fault detection process. In addition, such a hierarchical fault determination method helps a network administrator allocate resources more effectively, reduces troubleshooting time, improves reliability and quality of service of the network, and ensures continuity and stability of a user service.
(21) When receiving at least two pieces of first routing path information, the system may compare first nodes in these paths. If finding that the at least two paths have the same first node, it generally means that the node may be a fault point, because the node has a problem in different paths. This policy helps to quickly locate a routing node that may not operate normally due to overload, misconfiguration, or a hardware fault. Timely identification of a faulty node can reduce time of network interruption, increase a fault response speed, and maintain high availability of a network. A false positive rate can also be reduced because a faulty node is determined based on a consensus of a plurality of paths, rather than anomaly of a single path. The fault detection mechanism helps to improve stability and reliability of the network, optimize allocation of network resources, and improve overall quality of service of the network.
(22) When detecting that the faulty first routing node exists in the first routing path, the first service node transmits a path acquisition request to the management node. This mechanism ensures that when a faulty node exists in the network, the first service node can report the situation to a superior management node in time, thereby triggering a fault response and a path reconstruction procedure. Such a proactive error reporting mechanism enables a network administrator to quickly identify and locate a fault point, reducing time required for fault diagnosis. This allows the system to adjust a routing policy in real time, avoid a faulty node, and select a healthy path for data transmission, thereby improving robustness and reliability of the network, ensuring service continuity, and optimizing user experience. Generally, this policy reduces network interruption time and a potential data loss risk caused by a fault, and improves stability and efficiency of the entire distributed network.
(23) The routing data is fused with the first routing path to generate the first routing packet, and data routing is performed accordingly, which, by using packet fusion, simplifies a data transmission process, reduces overheads in the transmission, and improves data transmission efficiency. In addition, the third routing node adjacent to the first service node is determined as a next hop for data transmission, which may ensure that data has undergone precise path planning before entering a complex network environment, thereby reducing uncertainty of the data during transmission. The fusion and directional transmission method further helps to optimize utilization of network resources, reduce possible network congestion, improve overall network performance, and finally provide users with a faster and stable data transmission service.
(24) After path detection is performed on the first routing path and a detection result is acquired, routing data is acquired according to the data routing instruction, and data routing is performed based on the routing data when it is confirmed that no fault occurs in the at least one routing node, which ensures that a path passed by the data is verified before the data is transmitted, and effectively avoids data transmission failure caused by a path fault, thereby improving a success rate and reliability of data transmission. This further helps to reduce a network delay caused by a routing error or a faulty node, thereby optimizing data transmission efficiency. In addition, such a routing decision-making mechanism based on a real-time state enhances flexibility and adaptability of the network, so that the system can quickly respond to a network change, maintain service continuity, and improve overall network performance and user experience.
(25) A routing node adjacent to the first service node is determined as the third routing node, so that a controllable intermediate node is introduced during the detection, which helps to more accurately evaluate reachability and performance of the first routing path. By transmitting the detection packet carrying the first routing path information and receiving the feedback information of the third routing node, the system can effectively determine accessibility of the path, ensuring timely detection of a potential network problem. The path detection result is divided into the first detection result (the second service node can be detected) and the second detection result (the second service node cannot be detected), so that the system can clearly distinguish validity of the routing paths, thereby quickly responding and taking measures, such as selecting an alternate path or performing troubleshooting. Such a path detection mechanism improves a detection capability of the network, ensures high reliability of data transmission, also optimizes a failure diagnosis and recovery procedure, and finally improves stability and quality of service of an entire distributed network.
(26) When one fourth routing path is provided in the system, the fourth routing path is directly determined as the second routing path, and when a plurality of fourth routing paths are provided, the path with the highest transmission performance is selected as the second routing path, which ensures that the system can quickly switch to a reliable alternate path when the first routing path fails or is congested, thereby maintaining service continuity and stability. Secondly, by evaluating and selecting the path with optimal transmission performance, the system can provide a more efficient data transmission rate and a lower delay, thereby improving user experience and overall performance of the system. In addition, the policy further enhances flexibility and adaptability of a network, so that the system can dynamically adjust a routing policy according to a real-time network state, optimize resource allocation, and reduce a potential loss caused by a network problem, thereby finally improving reliability and efficiency of the entire distributed service system.
(27) When the faulty first routing node exists in the first routing path and a plurality of third routing paths are available for selection, one path not including the faulty node is selected from these third routing paths as the second routing path, thereby ensuring continuity and reliability of network communication and avoiding breaking of an entire communication link caused by a fault of a single node. By dynamically switching to the second routing path not including the faulty node, the system can quickly recover data transmission without affecting service continuity, thereby reducing an influence of the fault on service operation and improving service availability.

The foregoing descriptions are only an example of this application and are not intended to limit the scope of protection of this application. Any modification, equivalent replacement, improvement, and the like made within the spirit and scope of this application fall within the protection scope of this application.

What is claimed is:

1. A data routing method, performed by a management node, the method comprising:
generating a first routing path having a first service node as a start point;
transmitting the first routing path to the first service node, the first routing path including at least one routing node configured to perform data routing;
receiving a path acquisition request from the first service node, the path acquisition request being generated based on a faulty first routing node existing in the at least one routing node;
generating, based on the path acquisition request, a second routing path having the first service node as a start point; and
transmitting the second routing path to the first service node, the second routing path being different from the first routing path and not including the first routing node.

2. The method according to claim 1, wherein the generating the second routing path comprises:
acquiring a second routing node corresponding to the faulty first routing node, the second routing node being not faulty and not included in the first routing path; and
updating the faulty first routing node in the first routing path to the second routing node, to obtain the second routing path.

3. The method according to claim 1, wherein the generating the second routing path comprises:
determining a second service node located at an end point of the first routing path; and
regenerating the second routing path, by taking the first service node as the start point and the second service node as the end point, the second routing path not including the faulty first routing node.

4. The method according to claim 3, wherein the first service node and the second service node are located in a same distributed service system, and wherein the regenerating the second routing path comprises:
acquiring routing nodes in the distributed service system, and determining routing nodes in the distributed service system other than the faulty first routing node as target routing nodes; permutating the target routing nodes to obtain at least one target routing node path; and
fusing, for each target routing node path, the first service node, the target routing node path, and the second service node in an order of the first service node, the target routing node path, and the second service node, to obtain the second routing path corresponding to the target routing node path.

5. The method according to claim 1, wherein the generating the first routing path comprises:
receiving a data routing request from the first service node, the data routing request identifying a second service node located at an end point of the first routing path;
generating at least one third routing path having the first service node as the start point and the second service node as the end point, wherein routing nodes in different third routing paths are at least partially different; and
determining the first routing path based on the third routing paths.

6. The method according to claim 5, wherein the first service node and the second service node are located in a same distributed service system, and wherein the generating the at least one third routing path comprises:
acquiring routing nodes in the distributed service system, and permutating the routing nodes to obtain at least one fifth routing path; and
fusing, for each fifth routing path, the first service node, the fifth routing path, and the second service node in an order of the first service node, the fifth routing path, and the second service node, to obtain the third routing path corresponding to the fifth routing path.

7. The method according to claim 5, wherein the determining the first routing path comprises:
determining, when one third routing path is provided, the third routing path as the first routing path; and
determining, when a plurality of third routing paths are provided, a third routing path with a highest path transmission performance as the first routing path, or determining each of the third routing paths as the first routing path.

8. A data routing method, performed by a first service node, the method comprising:
receiving a first routing path having the first service node as a start point, the first routing path including at least one routing node configured to perform data routing;
transmitting a path acquisition request in response to a faulty first routing node existing in the at least one routing node;
receiving a second routing path based on the path acquisition request, the second routing path being different from the first routing path and not including the faulty first routing node; and
performing data routing according to the second routing path.

9. The method according to claim 8, wherein the receiving the first routing path comprises:
receiving at least one third routing path having the first service node as the start point, each third routing path including at least one routing node configured to perform data routing;
determining, when one third routing path is received, the third routing path as the first routing path; and
acquiring, when a plurality of third routing paths are received, a path transmission performance of each of the third routing paths, and determining a third routing path with a highest path transmission performance as the first routing path.

10. The method according to claim 8, wherein the transmitting the path acquisition request comprises:
transmitting the path acquisition request in response to the faulty first routing node existing in the first routing path and one third routing path being provided; and
transmitting the path acquisition request in response to the faulty first routing node existing in the first routing path, a plurality of third routing paths being provided, and the third routing paths other than the first routing path including the faulty first routing node.

11. The method according to claim 8, wherein after the receiving the first routing path, the method further comprises:
selecting, in response to the faulty first routing node existing in the first routing path, a plurality of third routing paths being provided, and the third routing paths other than the first routing path not including the faulty first routing node, one third routing path not including the faulty first routing node from the third routing paths other than the first routing path as the second routing path.

12. The method according to claim 11, wherein the selecting the one third routing path as the second routing path comprises:
determining, in a case that two third routing paths are provided and the third routing path other than the first routing path does not include the faulty first routing node, the third routing path other than the first routing path as the second routing path; and
determining, in a case that more than two third routing paths are provided, the third routing paths not including the faulty first routing node in the third routing paths other than the first routing path as fourth routing paths, and determining the second routing path based on the fourth routing paths.

13. The method according to claim 12, wherein the determining the second routing path comprises:
determining, in a case that one fourth routing path is provided, the fourth routing path as the second routing path; and
determining, in a case that a plurality of fourth routing paths are provided, a fourth routing path with a highest path transmission performance as the second routing path.

14. The method according to claim 8, wherein after the receiving the first routing path, the method further comprises:
performing path detection on the first routing path to obtain a path detection result;
wherein the path detection result indicates whether the faulty first routing node exists in the at least one routing node included in the first routing path.

15. The method according to claim 14, wherein the performing the path detection comprises:
determining a routing node that is in the first routing path and adjacent to the first service node as a third routing node;
transmitting, to the third routing node, a path detection packet carrying the first routing path, and receiving feedback information returned by the third routing node based on the path detection packet;
determining the path detection result as a first detection result in a case that the feedback information indicates that the path detection packet is capable of reaching a second service node;
wherein the first detection result indicates that the faulty first routing node does not exist in the at least one routing node included in the first routing path; and
determining the path detection result as a second detection result in a case that the feedback information indicates that the path detection packet is incapable of reaching the second service node;
wherein the second detection result indicates that the faulty first routing node exists in the at least one routing node included in the first routing path, and the second service node is a service node located at an end point of the first routing path.

16. The method according to claim 14, wherein after the performing the path detection, the method further comprises:
acquiring routing data in response to a data routing instruction; and
performing, in response to the faulty first routing node not existing in the at least one routing node, data routing based on the routing data and according to the first routing path; and
the performing data routing according to the second routing path comprises:
performing data routing based on the routing data and according to the second routing path.

17. The method according to claim 16, wherein the performing the data routing according to the first routing path comprises:
determining a routing node that is in the first routing path and adjacent to the first service node as a third routing node; and
performing packet fusion on the routing data and the first routing path, to obtain a first routing packet, and transmitting the first routing packet to the third routing node.

18. The method according to claim 16, wherein the performing the data routing according to the second routing path comprises:
determining a routing node that is in the second routing path and adjacent to the first service node as a second routing node; and
performing packet fusion on the routing data and the second routing path, to obtain a second routing packet, and transmitting the second routing packet to the second routing node.

19. A data routing apparatus, comprising:
at least one memory configured to store program code; and
at least one processor configured to read the program code and operate as instructed by the program code, the program code comprising:
generating code configured to cause at least one of the at least one processor to generate a first routing path having a first service node as a start point;
transmitting code configured to cause at least one of the at least one processor to transmit the first routing path to the first service node, the first routing path including at least one routing node configured to perform data routing;
receiving code configured to cause at least one of the at least one processor to receive a path acquisition request from the first service node, the path acquisition request being generated based on a faulty first routing node existing in the at least one routing node;
path code configured to cause at least one of the at least one processor to generate, based on the path acquisition request, a second routing path having the first service node as a start point; and
sending code configured to cause at least one of the at least one processor to transmit the second routing path to the first service node, the second routing path being different from the first routing path and not including the first routing node.

20. The data routing apparatus according to claim 19, wherein the path code is further configured to cause at least one of the at least one processor to:
acquire a second routing node corresponding to the faulty first routing node, the second routing node being not faulty and not included in the first routing path; and
update the faulty first routing node in the first routing path to the second routing node, to obtain the second routing path.
